(19) United States
(12) Patent Application Publication
(10) Pub. No.: US 2016/0294794 A1
(43) Pub. Date: Oct. 6, 2016

(54) Security System For Data Communications Including Key Management And Privacy

(71) Applicants: Aleksandar Mancic, Groningen (NL); Moses Silfen, Jerusalem (IL); Eric Greenberg, Woodmere, NY (US)

(72) Inventors: Aleksandar Mancic, Groningen (NL); Moses Silfen, Jerusalem (IL); Eric Greenberg, Woodmere, NY (US)

(21) Appl. No.: 15/088,838

(22) Filed: Apr. 1, 2016

Related U.S. Application Data
(60) Provisional application No. 62/143,067, filed on Apr. 4, 2015.

(51) Int. Cl. H04L 29/06

(52) U.S. Cl. CPC H04L 63/061; H04L 63/18; H04L 63/0421

(57) ABSTRACT

A security system and method that incorporates key management as well as provides privacy for its users. The security system and method removes all incentives for surveilling user communications in the search for personally identifiable information and usage patterns. This goal is achieved by ensuring that a snooper cannot make a distinction between two different users just by observing their communication. The system removes all personally identifiable information from open communication. The security system and method functions to anonymize data communications in relation to the user and the system.

### REFERENCE TO PRIORITY APPLICATION

This application claims priority to U.S. Provisional Application Ser. No. 62/143,067, filed Apr. 4, 2015, entitled “Method and System for Information Protection,” incorporated herein by reference in its entirety.

### FIELD OF THE DISCLOSURE

The subject matter disclosed herein relates to the field of security and cryptography and more particularly relates to a security system for data communications incorporating key management and privacy.

### BACKGROUND OF THE INVENTION

More and more today consumers and businesses are becoming increasingly dependent on their connected devices. Consequently, inherent privacy and security problems are making regular appearances in headline news. Whether it is a credit card breach of a major retail chain, the compromise of an institution's personal user records database, or a public official voicing concern about vulnerabilities in passenger airline Internet of Things (IoT) systems, it is clear that current standards and protocols are insufficient for provisioning secure and private communications.

Continuous advances in technologies have actually widened the potential threat by empowering bad actors who otherwise would not be able to obtain the computing resources for cracking systems in a reasonable time window. Today's cyber criminals can readily launch sophisticated attacks with consumer hardware. This surging criminal segment inflicts costly damages on companies charged with safely storing data.

Victims are constantly being targeted with methodologies including session hijacking, side channel exploits and man in the middle attacks. The number of infiltrations that fly under the radar are unknown leaving to speculation the magnitude of these damages.

When mentioning data security, it is often referred to protecting data from access by unauthorized entities. This view, however, is myopic and antiquated. All sensitive data must be protected at rest and not just during transit. The most practical way to achieve this form of data security is by employing encryption.

Modern day encryption standards, e.g., Advanced Encryption Standard (AES), Rivest-Shamir-Adlema (RSA), Digital Signature Algorithm (DSA), etc., have been put through rigorous trials and audits in both academia and private industry. They are almost universally accepted as powerful and effective solutions for protecting sensitive data.

Encryption essentially replaces the problem of securing a large amount of data by securing smaller, more manageable chunks of data known as a cryptographic key. The management of these keys is the single most important problem for encryption based data security schemes today. Key management refers to myriad aspects of a cryptographic key lifecycle: generation, storage, exchange, and usage, including the possibilities for key revocation or key replacement.

The widely available key management solutions on the market are each flawed in one or more ways. Most rely on a third party trust model, like the centralized trust paradigm for Certificate Authorities (CA) or individual public key infrastructure (PKI) solutions, at least for the key exchange part. These approaches help facilitate an effective attack vector for adversaries. The goal of the attacker is to obtain the private key, and there are many reasonably simple approaches to working backwards that achieve this goal.

Certificate authorities are essentially the banks of the Internet, and they attract a preponderance of attention. Numerous CA breaches have been reported in the past, and there is no reason that this scenario will likely change.

Most key management approaches do not take measures to protect keys, rendering their data protection as merely “security through obscurity.” They assume that for today's modern operating systems, local storage on user space is sufficient. This reasoning, however, is flawed. Even in a scenario where there is no active targeting of the device, all devices can be lost or stolen, and owners can simply forget to wipe their devices before discarding them. These are only a few potential leaks that suggest data encryption is the safe and responsible way to protect data.

But protecting sensitive data from eavesdroppers is not sufficient. Even with perfect key management in place, much can be inferred about the exchanged data simply by analyzing individual usage patterns and the accompanying metadata. For example, one may utilize encryption as a means to protect their own identity; but their identity can be inferred by observing the peers with whom they communicate.

The word privacy is often defined as the state in which one is not observed or disturbed by other people. In today's digital world, this concept is all but abandoned. Users are under constant surveillance from corporate ‘big data’ collectors (mainly for advertising purposes), malicious adversaries, and government agencies. Further, just because a company uses its data collection for seemingly harmless ad profiling, does not mean that sensitive data is not at risk. Information sharing increases user risk exposure by huge orders of magnitude. The complexity of all the variables involved with each new actor who has access to the data puts user data at risk of both active hacking attacks and of indirect vulnerabilities such as device theft or employee tampering.

Consequently, users are at risk of a multitude of privacy related attacks, from harassment to full-blown identity theft. This unprecedented level of privacy intrusion has been enabled by the availability of ever increasing computing power and storage capacity, allowing for automated high-capacity surveillance of every single data exchange on the Internet, as well as sophisticated attacks on data centers which often result in the leaking of private information of millions of users.

There is thus a need for a security system that is capable of preventing the leaking of a user's private information. The security system should also provide the capability of removing all personally identifiable information from open communication thereby preventing a man in the middle or other eavesdropper from identifying users by observing their communications.

### SUMMARY OF THE INVENTION

The present invention is a security system and method that incorporates key management as well as provides privacy for its users. The security system and method of the present invention removes all incentives for surveilling user communications in the search for personally identifiable information and usage patterns. This goal is achieved by ensuring that a snooper cannot make a distinction between two different users just by observing their communication. The system removes all personally identifiable information from open communication. In other words, the security system and method anonymizes data communications in relation to the user and the system.

The security system can be used to implement a turn-key solution for secure and anonymous communications. The security system platform can be used to implement a self-contained and self-maintained system providing users with top level security and anonymity for all their communications. The system does not have any third party dependencies and in one embodiment operates on the application layer.

In already deployed systems utilizing secure sockets layer (SSL)/transport layer security (TLS) and other protocols relying on certificate authorities the security system can be used as a separate secure channel to either transport or verify certificates exchanged during the handshake. This approach adds more control to legacy systems and increases resilience against most common certificate based attacks by ensuring that no one between the communicating parties injected a forged certificate. Systems hardened using the security system platform will still remain compliant with existent policies as the security system does not interfere with the SSL/TLS process in any way, except to break the connection if an intrusion is suspected.

The security system of the present invention can be used in numerous applications that require robust security and anonymity for both data exchange and data storage purposes, e.g., instant messaging, audio and video conferencing, gaming, payment processing, cloud applications, etc. In another embodiment, utilizing connection management and data processing facilities the security system can be used as a general purpose communication library even in applications where security is not of a paramount importance.

In an alternative embodiment, once two nodes establish a session, the same session may be used to securely exchange data outside of the security system network. The provided protected storage can be used to archive unrelated data. The File Management and Permissions service can be used to manage files stored on third party cloud services. The security system network can be used to transmit or verify certificates for other protocols including SSL/TLS, IPsec and secure shell (SSH).

The security system of the present invention thus provides anonymity whereby the network does not and cannot know personally identifiable details of users. When implemented for example in a corporate environment, the security system cannot know anything about employees using the security system. In addition, the security system does not have any knowledge whether any particular node belongs to an employee of a particular corporate entity. An additional benefit to the zero-knowledge security system platform is that it makes itself very uninteresting to hackers and other snooping adversaries.

By utilizing multiple independent channels, the security system network effectively thwarts injection attacks, most notably man in the middle (MiTM) attacks. For an attack to be successful, a malicious adversary is faced with a challenge of simultaneously seizing full control over all independent channels used during a particular key exchange. Note that after keys are exchanged, MiTM attacks are impossible without breaking into the devices themselves. The arduousness of this challenge increases by orders of magnitude with each additional channel employed. In the event of a suspected breach, the security system platform provides other means of protection against MiTM attacks through human verification, network verification and trusted peer verification.

In addition to security system key exchange additional means are provided to further strengthen the security system platform against injection attacks, especially in rare situations where independent channels are sparse. The security system provides network verification whereby any node can query the security system network against previous public key node negotiations of any node in the network. Trusted peer verification allows formerly polled paired nodes to be used for the same, under the assumption that all already verified peers are not compromised. Together with security system key exchange and human verification, users can create an encapsulated system which is nearly impervious to injection attacks.

The security system of the present invention can also be used to implement onion routing. Onion routing is a well-known technique for anonymous communication over a computer network. In an onion network, messages are encapsulated in layers of encryption, analogous to layers of an onion. The encrypted data is transmitted through a series of network nodes called onion routers, each of which “peels” away a single layer, uncovering the data's next destination. When the final layer is decrypted, the message arrives at its destination. The sender remains anonymous because each intermediary knows only the location of the immediately preceding and following nodes.

The security system platform allows users to further anonymize their internal communication by relaying traffic through their trusted peers. By utilizing only trusted peers as entry and exit nodes, the security system network is impervious to exit node vulnerabilities that have plagued public anonymous networks such as Tor. Since the user gets to choose which nodes will be used as traffic relays there is no logical possibility of a malicious adversary being able to associate identities of users by registering a large number of nodes and comparing requests entering and exiting the network. Onion routing using the security system network can be used both for internal communication as well as for regular network traffic.

In another embodiment, the security system can perform remote data access revocation. When using the security system File Sharing and Permissions service, a sender is able to finely control access to the transmitted data. All receiving nodes connect to the aforementioned service and request a permission, in the form of an unlock key, whenever they need to access and/or modify the controlled data. The data owner can at any point revoke access to those keys effectively rendering the remote data inaccessible. Under normal operating conditions (e.g., a clean system, or security system signed app) there is no possibility of circumventing remote data access revocation as access keys and decrypted data are never stored.

There is thus provided in accordance with the invention, a method of providing secure communications and anonymity in a network, comprising providing a plurality of hubs in communication with each other and in communication with a plurality of client nodes, a first client node establishing a first account-less session with a hub, the first client node transferring its public key to the hub utilizing a multi-channel key exchange over a plurality of channels, a second client node establishing a second account-less session with the hub, the second client node retrieving the first client node's public key from the hub, the second client node sending its public key to the first client node, and the first node and the second node establishing secure communications using their exchanged public keys.

### BRIEF DESCRIPTION OF THE DRAWINGS

The invention is herein described, by way of example only, with reference to the accompanying drawings, wherein:

FIG. 1 is a block diagram illustrating an example computer processing system adapted to implement the security system of the present invention;

FIG. 2 is a block diagram illustrating an example embodiment of the present invention;

FIG. 3 is a block diagram illustrating an example embodiment of the network architecture of the present invention;

FIGS. 4 and 5 are diagrams illustrating further aspects of some embodiments of the present invention;

FIGS. 6A and 6B are diagrams illustrating an example node initialization process in accordance with the present invention;

FIGS. 7A and 7B are diagrams illustrating an example client to hub session establishment process in accordance with the present invention;

FIGS. 8A and 8B are diagrams illustrating an example client to client session establishment process in accordance with the present invention;

FIGS. 9A, 9B, 9C and 9D are diagrams illustrating an example client to client key exchange process in accordance with the present invention; and

FIGS. 10 and 11 illustrate some embodiments of the present invention.

### DETAILED DESCRIPTION

In the following detailed description, numerous specific details are set forth in order to provide a thorough understanding of the invention. It will be understood by those skilled in the art, however, that the present invention may be practiced without these specific details. In other instances, well-known methods, procedures, and components have not been described in detail so as not to obscure the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

Any reference in the specification to a method should be applied mutatis mutandis to a system capable of executing the method. Any reference in the specification to a system should be applied mutatis mutandis to a method that may be executed by the system.

Throughout the specification and claims, the following terms take the meanings explicitly associated herein, unless the context clearly dictates otherwise. The phrases “in one embodiment,” “in an example embodiment,” and “in some embodiments” as used herein do not necessarily refer to the same embodiment(s), though it may. Furthermore, the phrases “in another embodiment,” “in an alternative embodiment,” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present invention may be written in any combination of one or more programming languages, including an object oriented programming language such as Java, Smalltalk, C++, C# or the like, conventional procedural programming languages, such as the “C” programming language, and functional programming languages such as Prolog and Lisp, machine code, assembler or any other suitable programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network using any type of network protocol, including for example a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented or supported by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The invention is operational with numerous general purpose or special purpose computing system environments or configurations. Examples of well-known computing systems, environments, and/or configurations that may be suitable for use with the invention include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

In addition, the invention is operational in systems incorporating sensors such as found in automated factories, in mobile devices such as tablets and smartphones, smart meters installed in the power grid and control systems for robot networks. In general, any computation device that can host an agent can be used to implement the present invention.

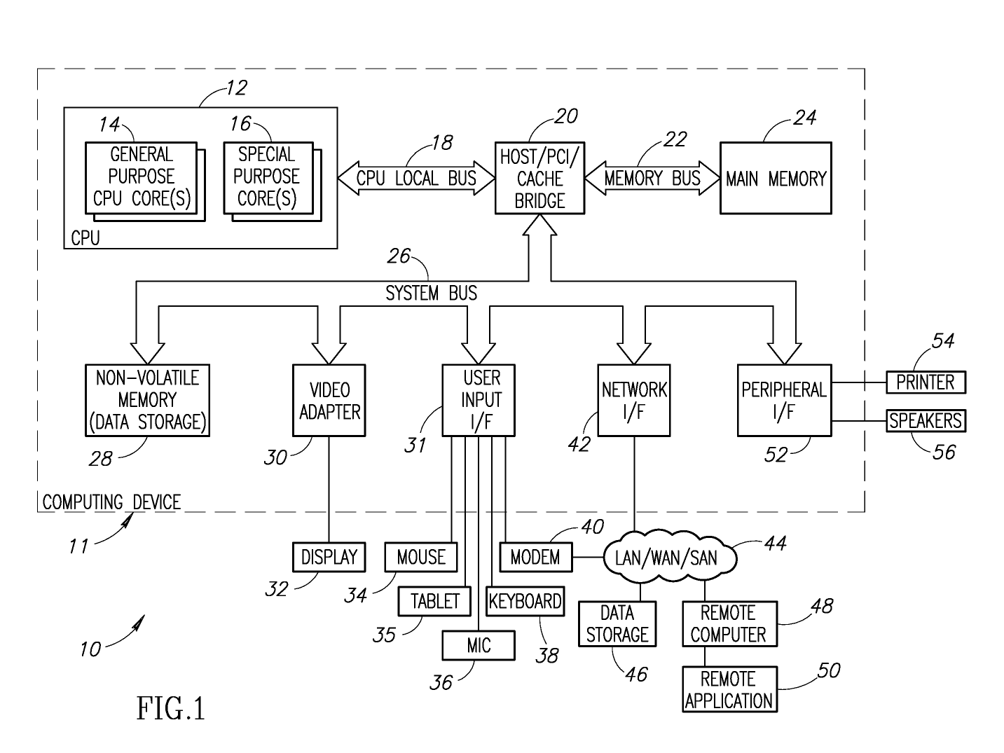

A block diagram illustrating an example computer processing system adapted to implement the security system of the present invention is shown in FIG. 1. The exemplary computer processing system, generally referenced 10, for implementing the invention comprises a general purpose computing device 11. Computing device 11 comprises central processing unit (CPU) 12, host/PIC/cache bridge 20 and main memory 24.

The CPU 12 comprises one or more general purpose CPU cores 14 and optionally one or more special purpose cores 16 (e.g., DSP core, floating point, etc.). The one or more general purpose cores execute general purpose opcodes while the special purpose cores execute functions specific to their purpose. The CPU 12 is coupled through the CPU local bus 18 to a host/PCI/cache bridge or chipset 20. A second level (i.e. L2) cache memory (not shown) may be coupled to a cache controller in the chipset. For some processors, the external cache may comprise an L1 or first level cache. The bridge or chipset 20 couples to main memory 24 via memory bus 20. The main memory comprises dynamic random access memory (DRAM) or extended data out (EDO) memory, or other types of memory such as ROM, static RAM, flash, and non-volatile static random access memory (NVSRAM), bubble memory, etc.

The computing device 11 also comprises various system components coupled to the CPU via system bus 26 (e.g., PCI). The host/PCI/cache bridge or chipset 20 interfaces to the system bus 26, such as peripheral component interconnect (PCI) bus. The system bus 26 may comprise any of several types of well-known bus structures using any of a variety of bus architectures. Example architectures include Industry Standard Architecture (ISA) bus, Micro Channel Architecture (MCA) bus, Enhanced ISA (EISA) bus, Video Electronics Standards Associate (VESA) local bus and Peripheral Component Interconnect (PCI) also known as Mezzanine bus.

Various components connected to the system bus include, but are not limited to, non-volatile memory (e.g., disk based data storage) 28, video/graphics adapter 30 connected to display 32, user input interface (I/F) controller 31 connected to one or more input devices such mouse 34, tablet 35, microphone 36, keyboard 38 and modem 40, network interface controller 42, peripheral interface controller 52 connected to one or more external peripherals such as printer 54 and speakers 56. The network interface controller 42 is coupled to one or more devices, such as data storage 46, remote computer 48 running one or more remote applications 50, via a network 44 which may comprise the Internet cloud, a local area network (LAN), wide area network (WAN), storage area network (SAN), etc. A small computer systems interface (SCSI) adapter (not shown) may also be coupled to the system bus. The SCSI adapter can couple to various SCSI devices such as a CD-ROM drive, tape drive, etc.

The non-volatile memory 28 may include various removable/non-removable, volatile/nonvolatile computer storage media, such as hard disk drives that reads from or writes to non-removable, nonvolatile magnetic media, a magnetic disk drive that reads from or writes to a removable, nonvolatile magnetic disk, an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

A user may enter commands and information into the computer through input devices connected to the user input interface 31. Examples of input devices include a keyboard and pointing device, mouse, trackball or touch pad. Other input devices may include a microphone, joystick, game pad, satellite dish, scanner, etc.

The computer 11 may operate in a networked environment via connections to one or more remote computers, such as a remote computer 48. The remote computer may comprise a personal computer (PC), server, router, network PC, peer device or other common network node, and typically includes many or all of the elements described supra. Such networking environments are commonplace in offices, enterprise-wide computer networks, intranets and the Internet.

When used in a LAN networking environment, the computer 11 is connected to the LAN 44 via network interface 42. When used in a WAN networking environment, the computer 11 includes a modem 40 or other means for establishing communications over the WAN, such as the Internet. The modem 40, which may be internal or external, is connected to the system bus 26 via user input interface 31, or other appropriate mechanism.

The computing system environment, generally referenced 10, is an example of a suitable computing environment and is not intended to suggest any limitation as to the scope of use or functionality of the invention. Neither should the computing environment be interpreted as having any dependency or requirement relating to any one or combination of components illustrated in the exemplary operating environment.

In one embodiment, the software adapted to implement the system and methods of the present invention can also reside in the cloud. Cloud computing provides computation, software, data access and storage services that do not require end-user knowledge of the physical location and configuration of the system that delivers the services. Cloud computing encompasses any subscription-based or pay-per-use service and typically involves provisioning of dynamically scalable and often virtualized resources. Cloud computing providers deliver applications via the internet, which can be accessed from a web browser, while the business software and data are stored on servers at a remote location.

In another embodiment, software adapted to implement the system and methods of the present invention is adapted to reside on a computer readable medium. Computer readable media can be any available media that can be accessed by the computer and capable of storing for later reading by a computer a computer program implementing the method of this invention. Computer readable media includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Communication media typically embodies computer readable instructions, data structures, program modules or other data such as a magnetic disk within a disk drive unit. The software adapted to implement the system and methods of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the system and methods of the present invention, and to the extent that a particular system configuration is capable of implementing the system and methods of this invention, it is equivalent to the representative digital computer system of FIG. 1 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk, CDROM, DVD, flash memory, portable hard disk drive, etc. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or by combinations of special purpose hardware and computer instructions.

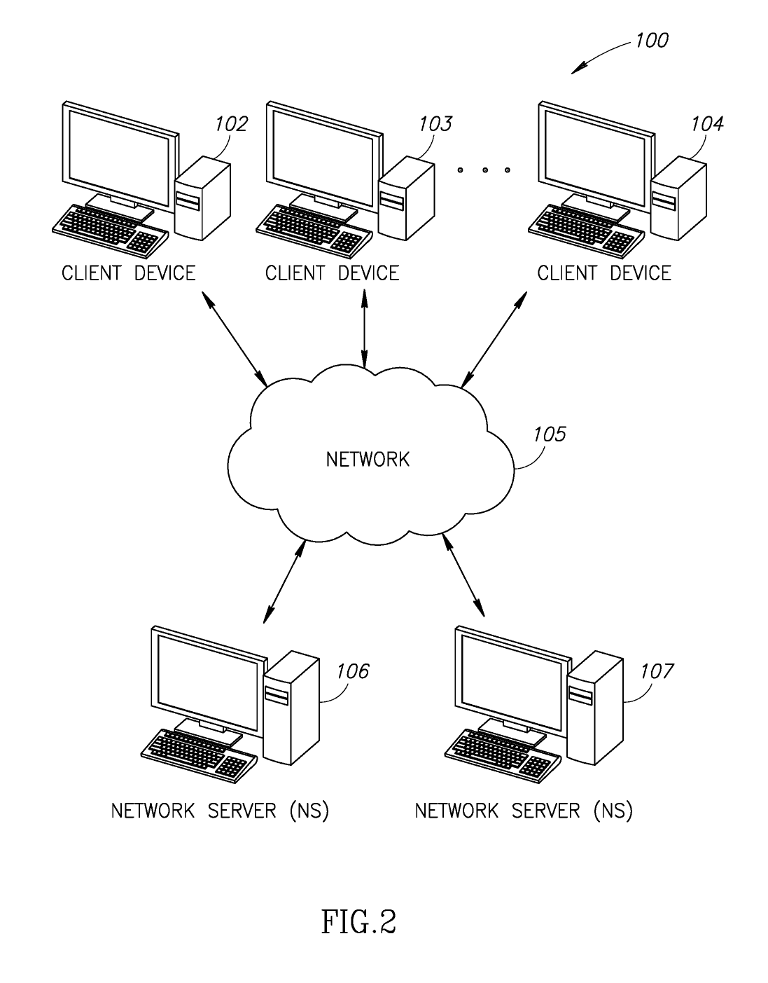

One embodiment of an environment in which the present invention may operate is illustrated in FIG. 2. Not all of these components, however, may be required to practice the invention, and variations in the arrangement and type of the components may be made without departing from the spirit or scope of the present invention. In some embodiments, the system and method may include a large number of members and/or concurrent transactions. In other embodiments, the system and method are based on a scalable computer and network architecture that incorporates varies strategies for assessing the data, caching, searching, and database connection pooling. An example of the scalable architecture is an architecture that is capable of operating multiple servers.

In embodiments, members of the computer system 102-104 include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, programming may include either Java, .Net, QT, C, C++ or other suitable programming language.

In embodiments, member devices 102-104 may be further configured to receive a message from another computing device employing another mechanism, including, but not limited to email, Short Message Service (SMS), Multimedia Message Service (MMS), instant messaging (IM), internet relay chat (IRC), mIRC, Jabber, and the like or a Proprietary protocol.

In embodiments, network 105 may be configured to couple one computing device to another computing device to enable them to communicate. In some embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

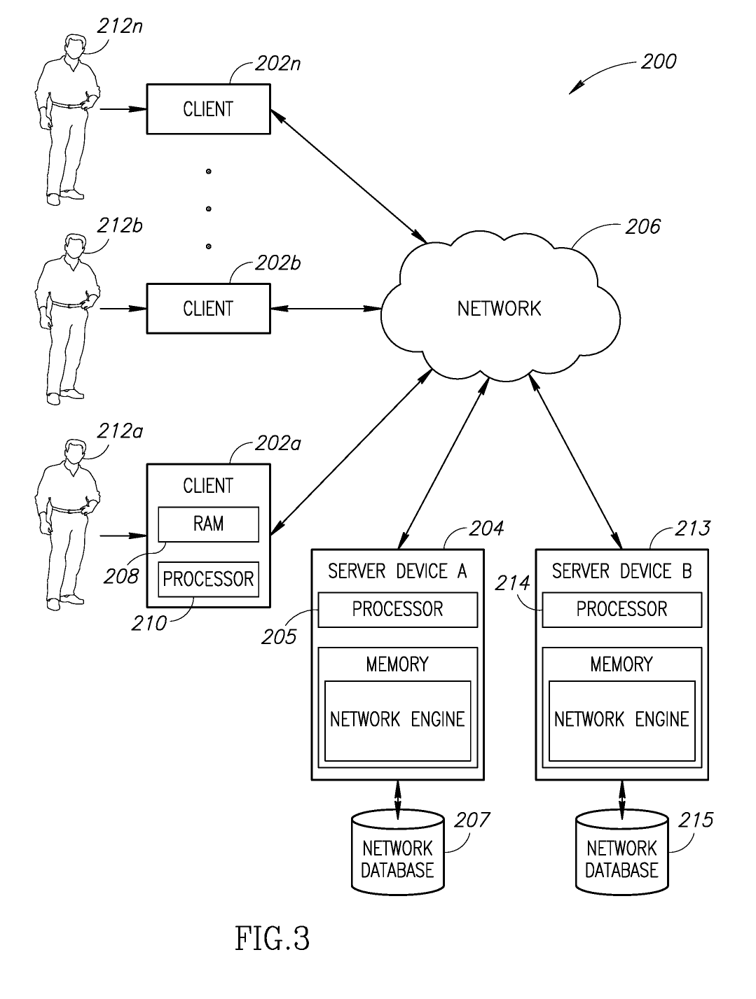

A block diagram illustrating an example embodiment of the network architecture of the present invention that supports the method and system is shown in FIG. 3. The member devices 202a, 202b thru 202n shown each at least includes a computer readable medium, such as a random access memory (RAM) 208 coupled to a processor 210 or FLASH memory. The processor 210 may execute computer-executable program instructions stored in memory 208. Such processors comprise a microprocessor, an ASIC, and state machines. Such processors comprise, or may be in communication with, media, for example computer-readable media, which stores instructions that, when executed by the processor, cause the processor to perform the steps described herein.

Embodiments of computer-readable media may include, but are not limited to, an electronic, optical, magnetic, or other storage or transmission device capable of providing a processor, such as the processor 210 of client 202a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, a client device 202a may be any type of processor-based platform that is connected to a network 206 and that interacts with one or more application programs. Client devices 202a-n may operate on any operating system capable of supporting a browser or browser-enabled application, such as Microsoft, Windows, or Linux. The client devices 202a-n shown may include, for example, personal computers executing a browser application program such as Microsoft Corporation's Internet Explorer, Apple Computer, Inc.'s Safari, Mozilla Firefox, and Opera. Through the client devices 202a-n, users, 212a-n communicate over the network 206 with each other and with other systems and devices coupled to the network 206. As shown in FIG. 1B, server devices 204 and 213 may be also coupled to the network 206.

In some embodiments, the term “mobile electronic device” may refer to any portable electronic device that may or may not be enabled with location tracking functionality. For example, a mobile electronic device can include, but is not limited to, a mobile phone, Personal Digital Assistant (PDA), Blackberry™, Pager, Smartphone, or any other reasonable mobile electronic device. For ease, at times the above variations are not listed or are only partially listed, this is in no way meant to be a limitation.

In some embodiments, the terms “proximity detection,” “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth; GPS accessed using any reasonable form of wireless and/or non-wireless communication; Wi-Fi server location data; Bluetooth™ based location data; triangulation such as, but not limited to, network based triangulation, Wi-Fi server information based triangulation, Bluetooth server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

In some embodiments, near-field wireless communication (NFC) can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less.

In some embodiments, NFC may operate at 13.56 MHz on ISO/IEC 18000-3 air interface and at rates ranging from 106 Kbit/s to 424 Kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable devices within close proximity of each other.

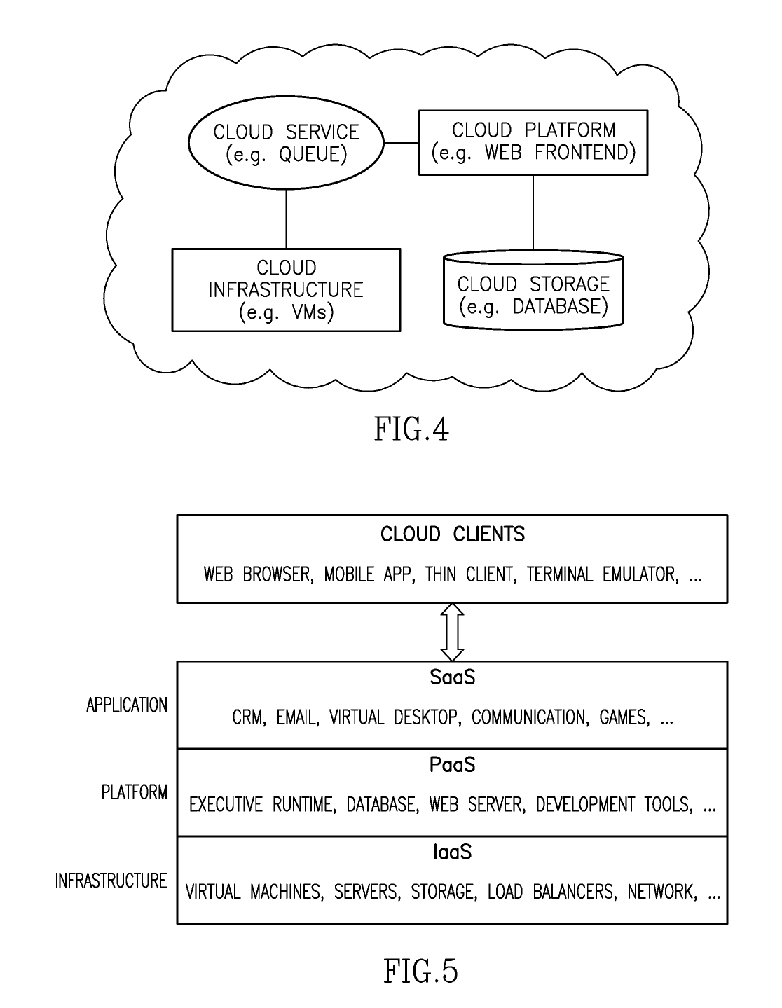

For purposes of the instant description, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user). In some embodiments, the instant invention offers/manages the cloud computing/architecture as, but not limiting to: infrastructure a service (IaaS), platform as a service (PaaS), and software as a service (SaaS). FIGS. 4 and 5 illustrate schematics of exemplary implementations of the cloud computing/architecture.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, Basic, AJAX, JavaScript). The aforementioned examples are, of course, illustrative and not restrictive.

### Security System/Platform

The security system (also referred to as a security platform) of the present invention is a security solution for data communications designed specifically to address both key management and privacy in such way that neither the exchanged data nor any personally identifiable information are readable without the explicit consent of the end-user. The platform is uniquely hardened to resist attacks both from the outside as well as from the inside.

The security system covers managing individual accounts, secure key exchange, data protection in stored and transit states and other features. It also allows for third-party service providers and developers to easily piggyback on the security system to take advantage of its benefits of secure and private communication.

Security system hubs provide the backbone of the system and together form the security system network. While their primary function is to maintain a security system node registry and to relay messages between security system nodes, hubs also optionally play a role in the security system key exchange process providing at least one secure channel for the key exchange.

Every security system node has a list of hubs along with their node keys which, through an authenticated Diffie-Hellman exchange (DHE), allows for a secure session with any other hubs. Once a session is established, the nodes update their hub list allowing for easy scalability of the system, as well as on-demand key revocation in case of a suspected breach.

Communication with the security system network occurs on the application layer which effectively improves security of already deployed systems and services. In one embodiment, for example, the security system platform is grafted on top of an already deployed TLS-protected service thus reducing the risk of eavesdropping in the event of a certificate authority (CA) breach. It could also be used through the well-known Tor network to further increase anonymity.

In addition to serving as a backbone, security system hubs offer both users and services the ability to store their data in a secured cloud maintained by the hubs. This feature allows for persistence, service single sign-on, and seamless cloud backups.

Security system hubs also serve as facilitators when a peer-to-peer (P2P) connection is desired. Given that many connected devices are behind routers and firewalls executing network address translation (NAT), when a P2P connection is required security system hubs perform NAT traversal, if needed, which allows for a direct connection between the clients involved. After disconnecting from the security system network, those users can still maintain communication for the duration of their current session.

To ensure anonymity of the security system platform, hubs do not produce any logs, or traces, and they do not track active nodes. Any relayed data is deleted immediately upon delivery or after the set expiration time. Coupled with accounts that require no personally identifiable data, this approach guarantees that all security system users remain anonymous to the network.

An additional benefit of this policy is that it makes the security system network unattractive to hackers and government agencies as there is nothing to be gained from cracking into the security system network.

In one embodiment of the present invention, a security system network is a network of equally treated nodes which all communicate in a uniform way and share the same basic properties. In some embodiments, the present invention consists of three types of nodes: (1) hubs, (2) services, and (3) clients. In some embodiments of the present invention, hubs are the backbone of the security system network and they hold cloud based storage for the node accounts, relayed (i.e. offline) data delivery and other network maintenance tasks. In some embodiments of the present invention, hubs take the responsibility of being a guaranteed secure channel in a multichannel key exchange process. In some embodiments of the present invention, hubs are a critical component in the entire security system stack.

In some embodiments of the present invention, one goal of the security system network is to provide both strong security and high anonymity to its users. In some embodiments of the present invention, in order to achieve those goals, the security system uses state of the art end-to-end encryption, multichannel key exchange procedures, ephemeral sessions and password protected storage coupled with an account-less system and no tracking and no logging policies.

In some embodiments, the present invention is a system and at least one method to achieve high secrecy and privacy. In some embodiments of the present invention, a node is a single security system enabled entity, unless stated otherwise it refers to a security system client. In some embodiments of the present invention, a node ID is a unique identifier (i.e. an address) of each security system node in the system. In one embodiment of the present invention, a default node ID is a 64-bit address. In some embodiments of the present invention, an identity key is a key pair generated by a security system node used for authentication and signing of the exchanged data through the security system network. In some embodiments of the present invention, unless otherwise stated, an identity key refers to the public portion of the identity key.

In some embodiments of the present invention, an asymmetric key pair is a public/private key pair. In some embodiments of the present invention, an asymmetric key pair is an Rivest-Shamir-Adlema (RSA) and digital signature algorithm (DSA) key with the matching strength of the overall system. In some embodiments of the present invention, a symmetric key is used for actual data encryption. In some embodiments of the present invention, a symmetric key pair is advanced encryption standard (AES) 128 and 256 bit variants.

In some embodiments of the present invention, a hash is a hash function or hashed representation of some data using a cryptographically safe hashing algorithm. In some embodiments of the present invention, a hash is secure hash algorithm (SHA)-256. In some embodiments of the present invention, a key derivation function (KDF) refers to Password-Based Key Derivation Function 2 (PBKDF2) and scrypt. In some embodiments of the present invention, the term Diffie-Hellman (DH) refers to a Diffie-Hellman key exchange procedure.

In some embodiments of the present invention, a session is an established session between two nodes, authenticated by each other and with an exchanged ephemeral session key used for encrypting sensitive data. In some embodiments of the present invention, a message is a main unit of data exchanged between two security system nodes.

In some embodiments of the present invention, the main features of the security system include: (1) protected storage, (2) session establishment, (3) account creation, (4) authentication, (5) multichannel key exchange, and (6) the actual data exchange. In some embodiments of the present invention, the above six features form a system that provides end-to-end encryption and perfect forward and backward secrecy while retaining high anonymity.

### Session Establishment

In some embodiments of the present invention, before communication between security system nodes can commence, a successful agreement must be performed to establish a session. In some embodiments of the present invention, an established session results in a unique symmetric key (session_key), which both parties agree to and is used to encrypt all the sensitive data exchanged between two nodes during that session. In some embodiments of the present invention, this action is performed so that each session can be individually encrypted to preserve a perfect forward and backward secrecy.

In some embodiments of the present invention, to establish a session, an authenticated Diffie-Hellman key exchange is performed, using previously exchanged identity keys (described in more detail infra) as authenticators to sign the exchanged DH key parts, thus preventing any feasible MITM attack. In some embodiments of the present invention, this is possible due to the fact that the private part of any node's identity key never leaves the device it was generated on, and it never leaves the protected storage on it preventing incidental leaks.

In some embodiments of the present invention, a special case exists in a situation where a client connects to a hub, where the hub cannot know the identity of the connecting node upfront, especially not prior to the account creation, so it cannot verify the node's signature. In some embodiments of the present invention, in this situation, it is the requesting node's sole responsibility to authenticate the established session. In some embodiments of the present invention, the node is able to do that because each security system node is pre-configured with a full list of all security system hubs together with their public identity keys. In some embodiments of the present invention, this list can be securely updated once a successful session is established between any node and a security system hub (described in more detail infra).

In some embodiments of the present invention, for a successful MITM attack on DH key exchange the attacker needs to generate two key pairs and direct them to both sides, replacing the original intended keys, but the attacker cannot know the hub's private identity key to sign the key pair sent to the client. In some embodiments of the present invention, this action ensures that the client will automatically refuse any connection not signed by the connected hub effectively thwarting a potential MITM attack.

In some embodiments of the present invention, the same process is used when establishing a session between two nodes through a security system hub (i.e. a relayed session) in which case the security system network serves only as a data carrier. In some embodiments of the present invention, the above example is not applicable for client-to-client session establishment, as both clients need to exchange their keys prior to establishing a session, and verify each other's signature before declaring a session valid.

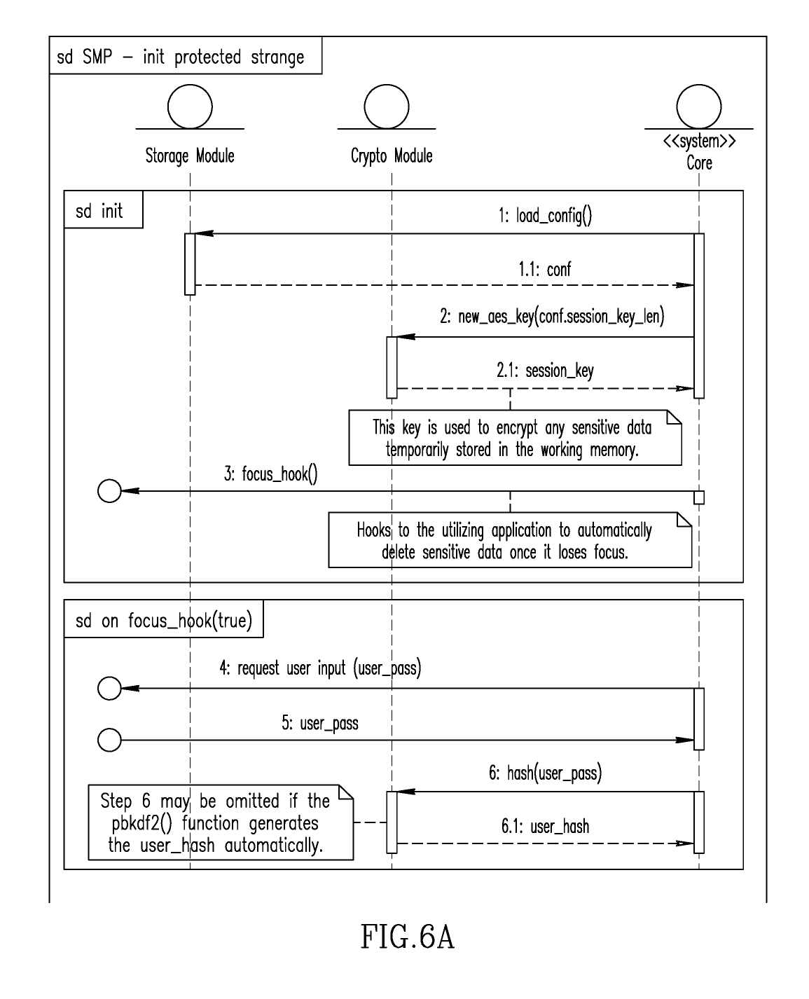

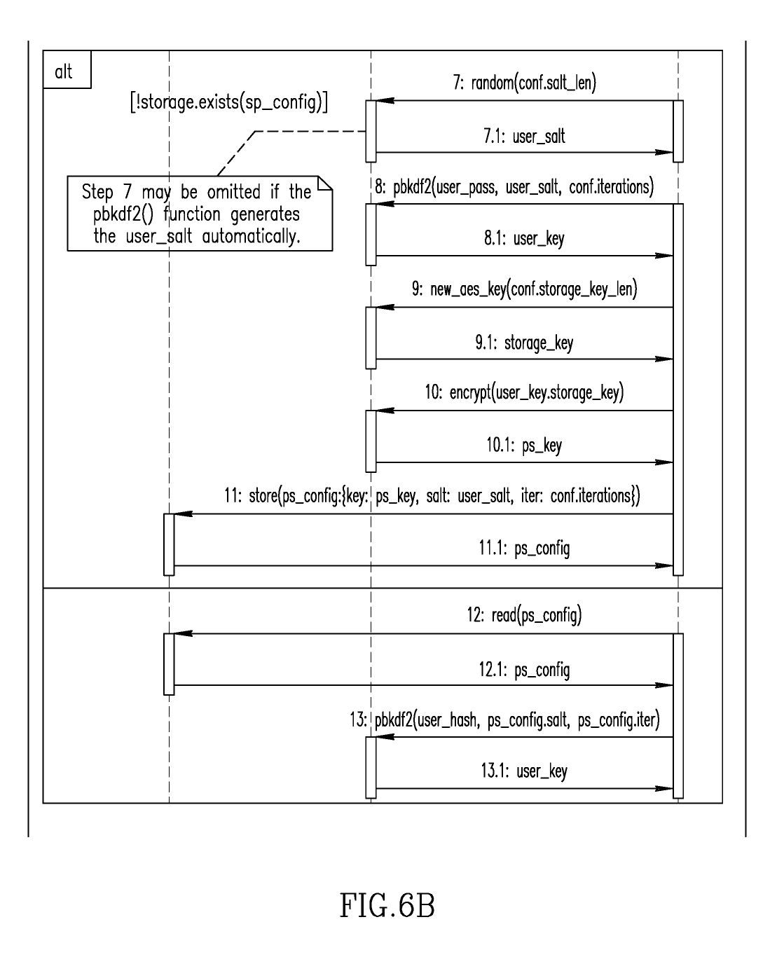

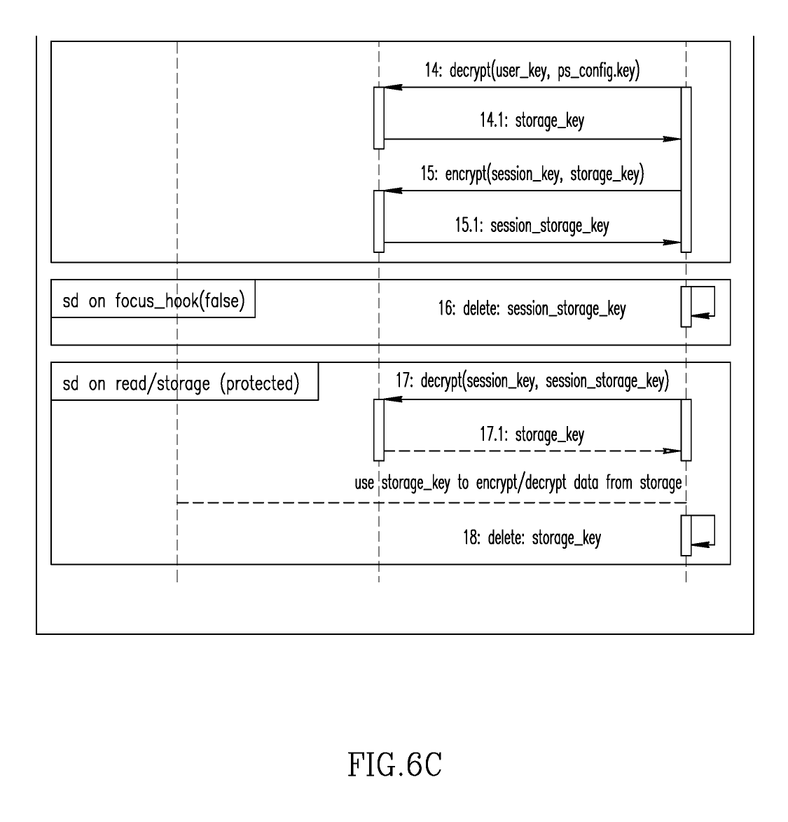

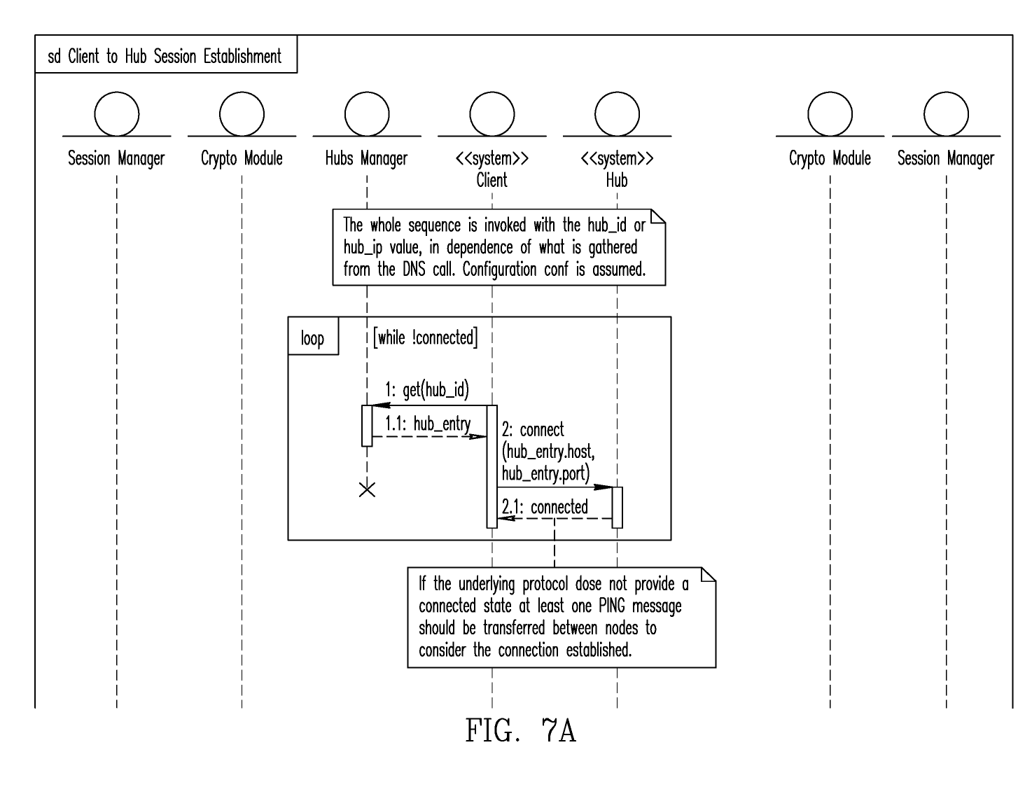

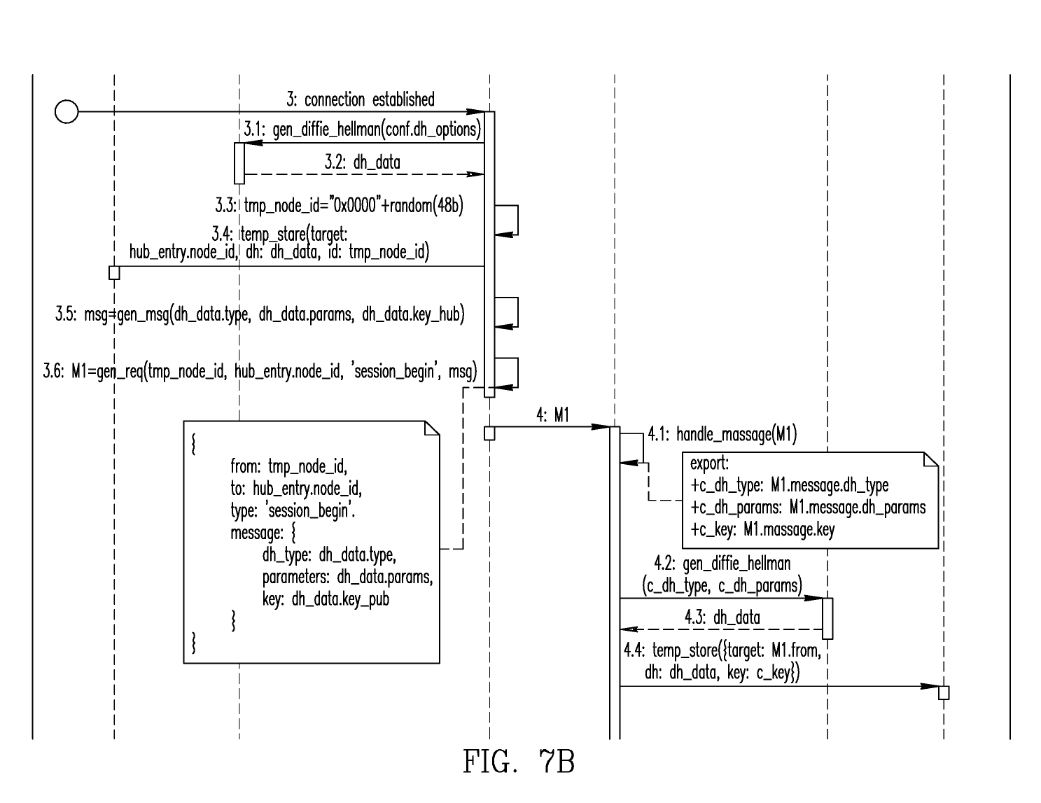

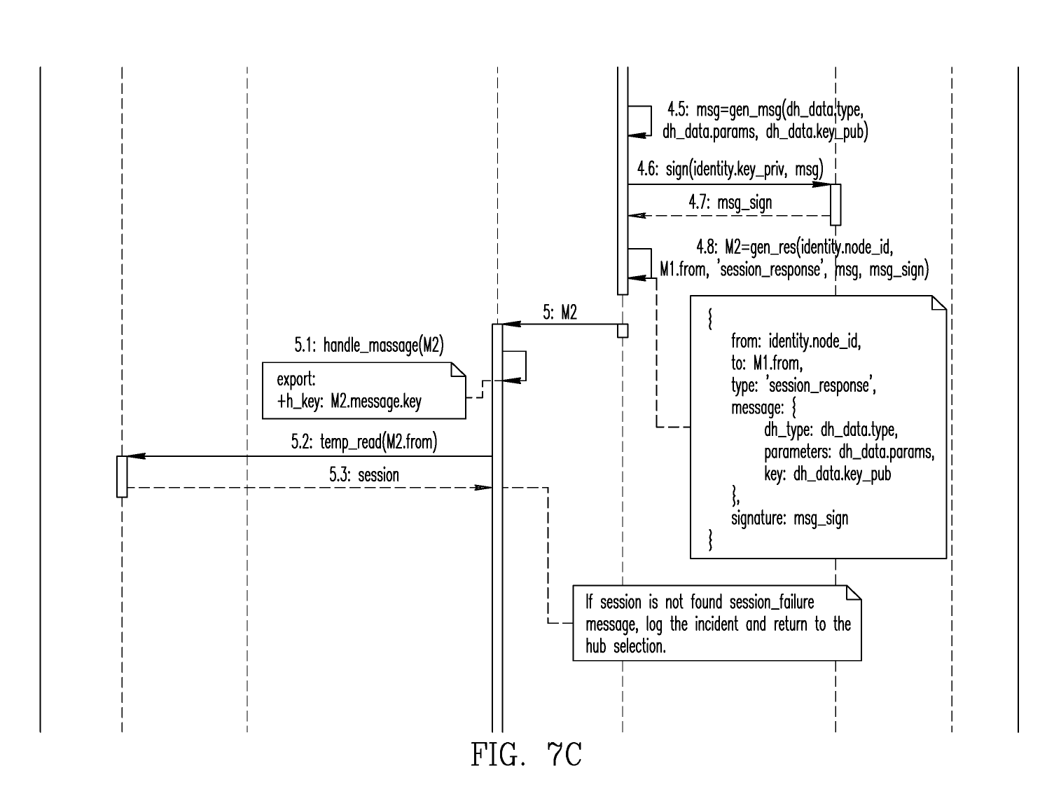

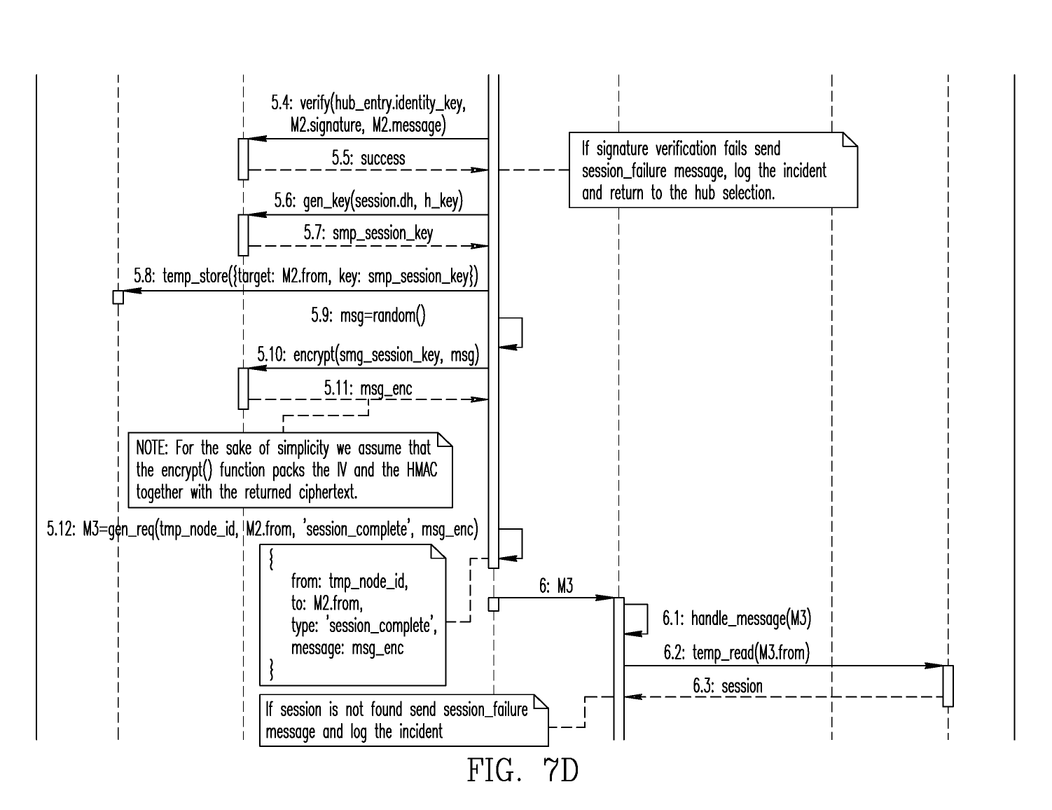

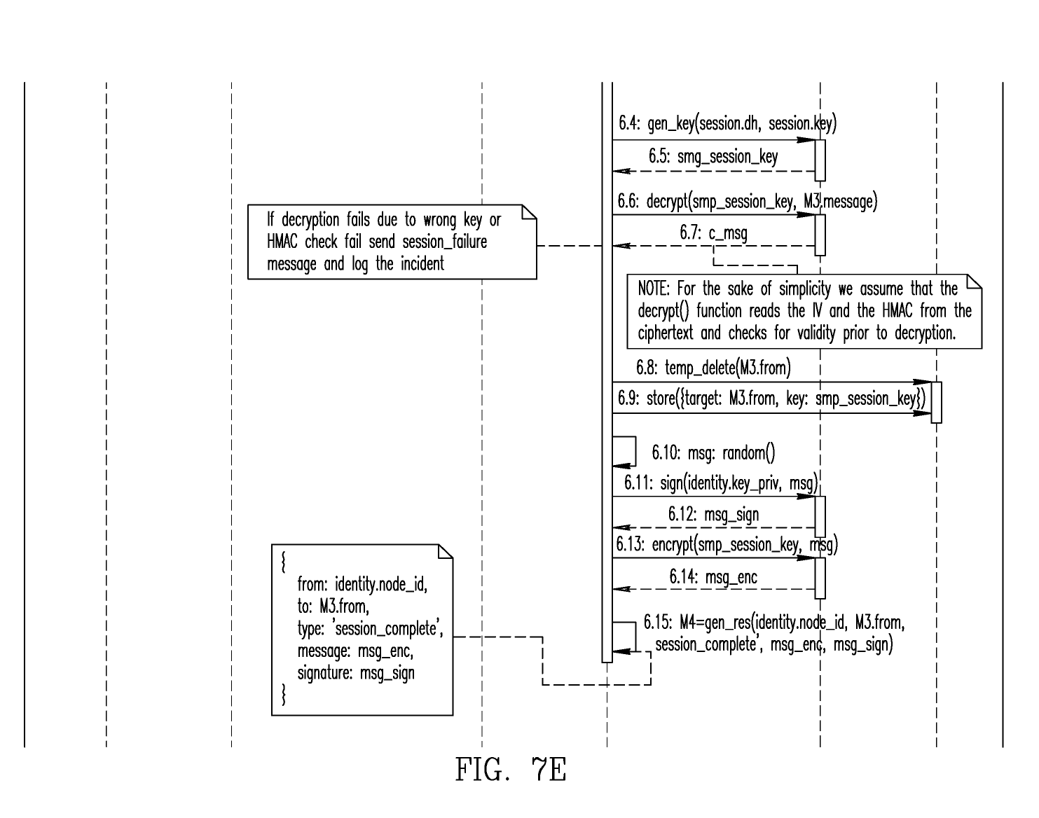

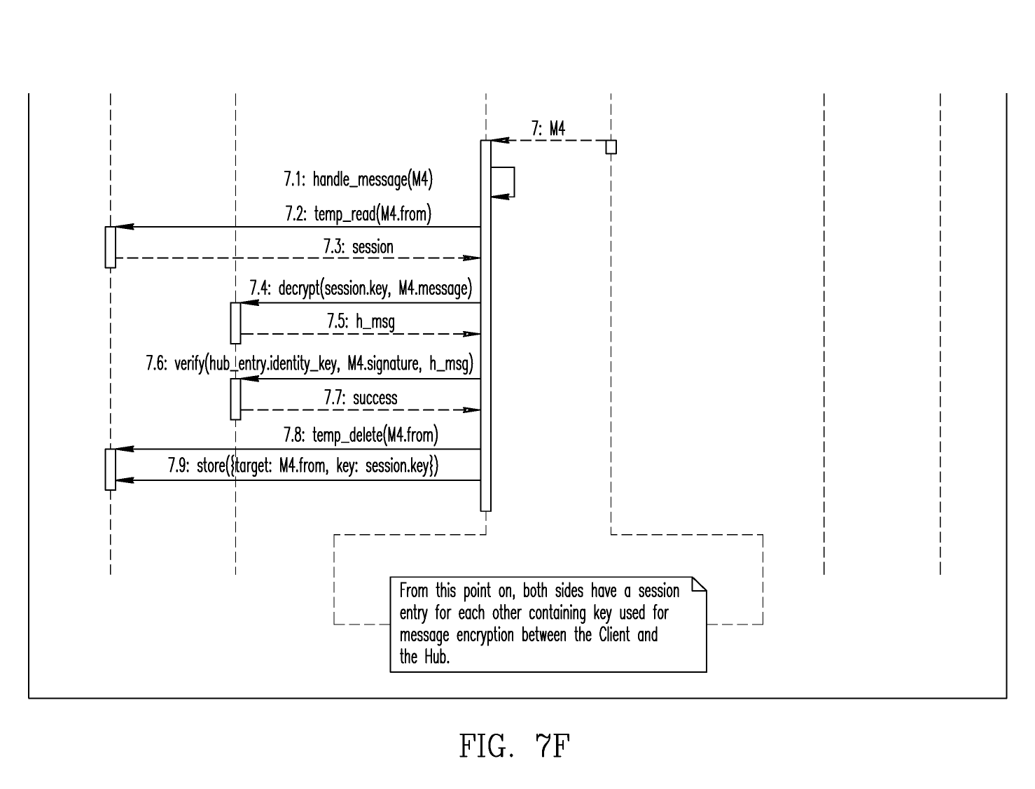

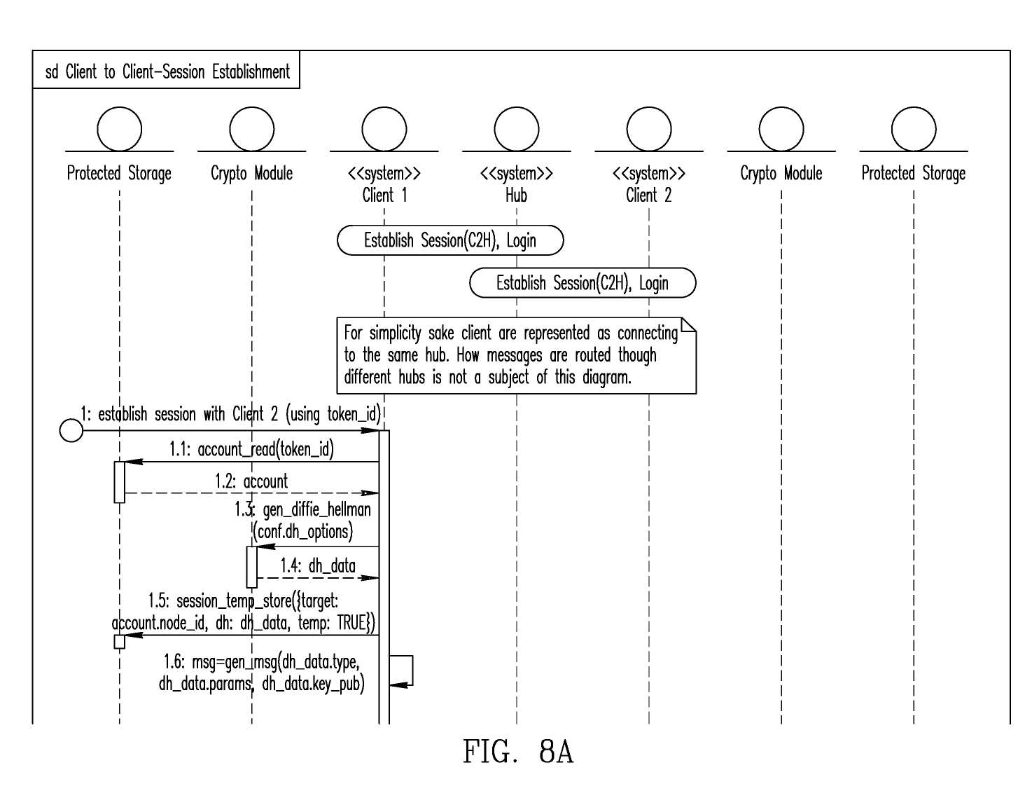

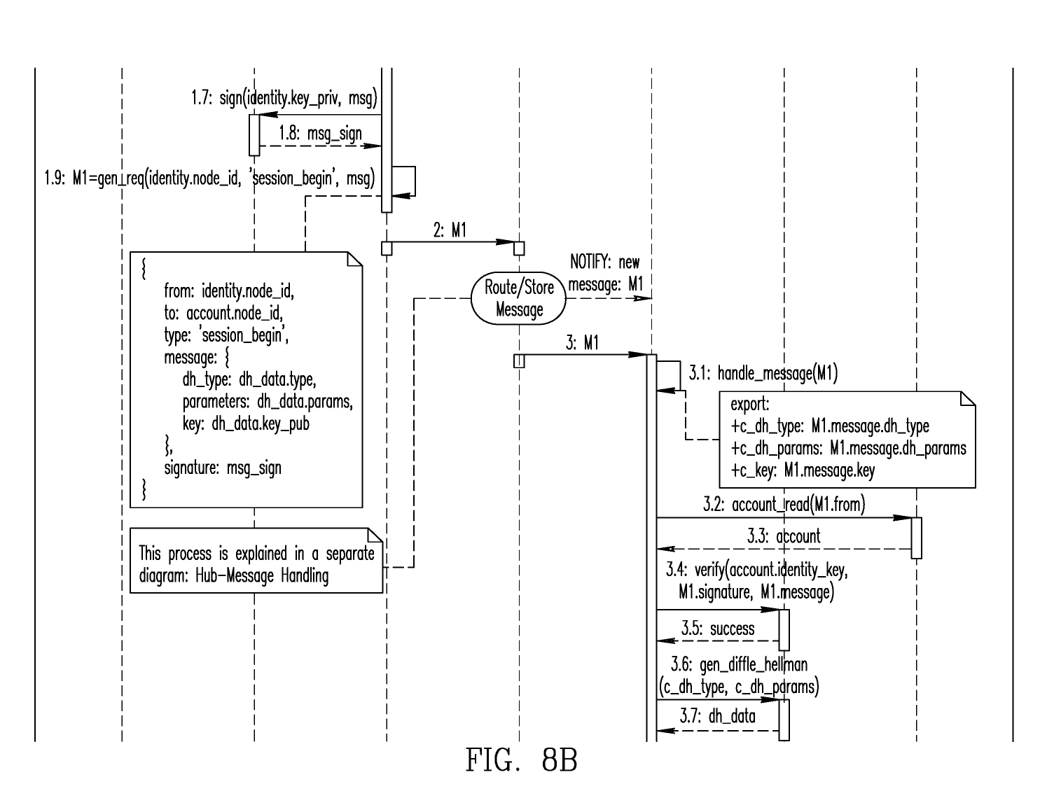

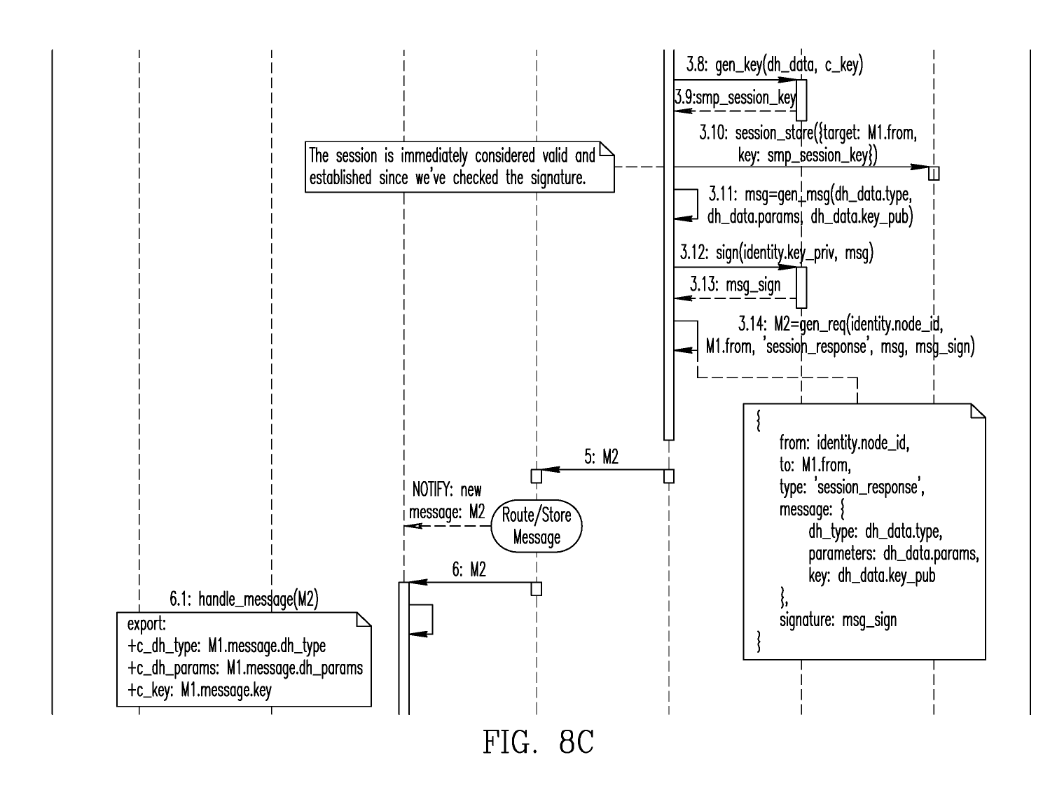

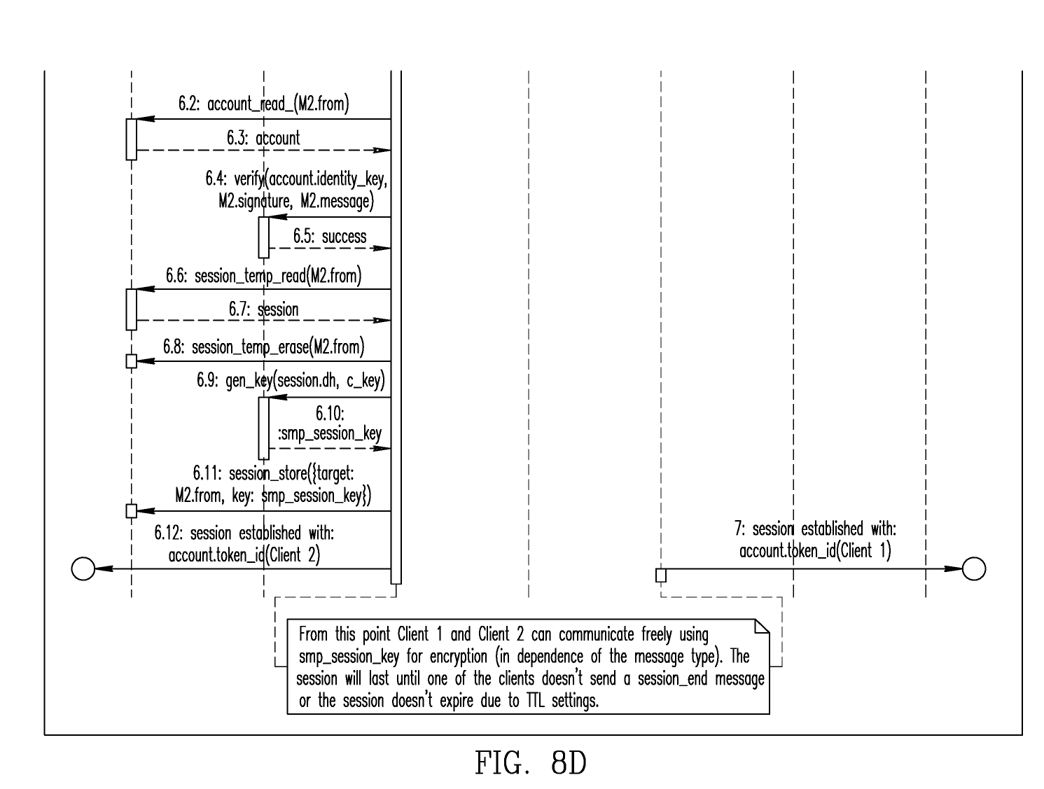

Diagrams illustrating an example node initialization process in accordance with the present invention are shown in FIGS. 6A and 6B. Diagrams illustrating an example client to hub session establishment process in accordance with the present invention are shown in FIGS. 7A and 7B. Diagrams illustrating an example client to client session establishment process in accordance with the present invention are shown in FIGS. 8A and 8B.

### Account Creation and Authentication

In some embodiments of the present invention, the security system is an account-less system. In some embodiments of the present invention, the security system does not use accounts in the traditional sense of the word. In some embodiments of the present invention, a security system user is never required to enter any personally identifiable information that would tie them to an account. In some embodiments of the present invention, the only required user input is in form of their own password for their local protected storage (described supra). Even that password, however, never leaves the device even in a hashed form. In some embodiments of the present invention, the security system account instead holds a unique node ID (i.e. node address) and a matching public identity key for any given node in the system.

In some embodiments of the present invention, an account is automatically generated when first joining the security system network. In some embodiments of the present invention, this process happens in two stages. In some embodiments of the present invention, first the joining node generates its own identity key pair (i.e. private and public) and then with the public identity key requests a new account from the hub in its local market network. In some embodiments of the present invention, a hub then generates a unique random node ID and creates an account entry in the security system network tying the generated node ID to the provided public identity key.

In some embodiments of the present invention, a node is able to authenticate to the security system network by providing its node ID along with a login message signed by its private identity key. In some embodiments of the present invention, any hub in the security system network can check that signature to verify the node's authenticity. In some embodiments of the present invention, the identity key pair generated in this step is also used when exchanging data with other nodes as other nodes are only aware of a node ID and public key of any node they've exchanged keys with. In some embodiments of the present invention, this ensures that the users remain anonymous throughout the entire security system network as no personally identifiable data is exchanged through it.

### Security System Node Registry

In one embodiment, the security system is an account-less system. Node registries in the security system network only serve to uniquely distinguish between devices. Instead of accounts, the security system platform provides individual users with their own unique virtual addresses (i.e. node IDs), while the users themselves bring their public node key into the mix to form a node entry. These two items of information represent the only “identity” information to which the security system has access as no other information is ever exposed by the security system network. Given that the security system uses a signature challenge over a random field to authenticate users, not even a password is required to log on to the security system network.

The security system does not require any personally identifiable information from its users. Only (1) the user's public key and (2) the node ID, which are assigned randomly with no user interaction and are not based on any users' data are the only two pieces of data the security system retains. These two pieces of randomly generated data are removed from the security system once a user uninstalls a security system application, leaving no trace of their existence on the network.

Since security system node entries are device-bound, the security system platform allows for sharing between all security system powered applications on the same device. This allows users to have their contacts and message history available in different security system powered applications. In addition, a Device Linking and Migration service allows users to tie-in multiple devices under the same node entry providing easy contact and data syncing across devices.

### Security System Key Exchange

The security system of the present invention provides a multi-channel key exchange process. It is a powerful key exchange process that thwarts common attacks associated with this aspect of key management, most notably man in the middle attacks (MiTM). Instead of requiring implicit service trust (e.g., hubs vouching for nodes' certificates) or relying on third-party trust (e.g., certificate authorities), the security system utilizes multiple, variable and mutually independent cascading channels to exchange keys between its nodes. This is performed by generating a separate key for each channel and then encrypting it using a key from the previous channel in the chain before sending. The last key in this chain encrypts the actual public node key that is the subject of key exchange and stores it on the security system network to be picked up by the intended recipient. While the node public key is, as its name implies, “public,” it is transferred in encrypted form to prevent a potential attacker from modifying the key during transfer.

This results in a situation where a potential attacker would need to simultaneously seize full control (i.e. read, modify and block) over all the channels used for the key exchange in order to perform a MiTM attack. The number of potential channels used for the key exchange is practically without limitation. The extent of this statement depends upon the platforms used, as well as the desired security level. Each added channel increases the difficulty of performing an active MiTM attack by an order of magnitude.

Once the public node keys are exchanged, the nodes can establish an end-to-end secure session between one another using authenticated Diffie Hellman key exchange as a cross-check against their authenticated node keys. Users can be quite certain that their communications are truly private.

In some embodiments of the present invention, the requirements for the multichannel key exchange scheme include: (1) a minimum of two channels for the key exchange; (2) at least one of the key exchange channels is secure and directly accessible by the parties participating in a key exchange procedure; and (3) key exchange channels are independent from each other such that one channel cannot access or alter the data being exchanged through another channel in any feasible way.

In some embodiments of the present invention, the required secure channel is provided by the security system network itself. In some embodiments of the present invention, other channels can be secure or insecure in accordance with the user's preferable way of communicating with their peers.

In some embodiments of the present invention, the security system key exchange procedure is a minimum two-channel key exchange. In some embodiments of the present invention, the required secure channel is provided by the security system network (i.e. a hub). In some embodiments of the present invention, the short message service (SMS) or an email provider function as a channel. In some embodiments of the present invention, identity keys described supra have already been generated and are securely connected to their respective security system hubs. In some embodiments of the present invention, the goal is to exchange the public identity keys to make a MiTM attack practically unfeasible.

In some embodiments of the present invention, the multichannel key exchange procedure is divided into two main parts: (1) establishing a temporary session, and (2) exchanging the keys through the temporary session.

In some embodiments of the present invention, to begin the key exchange procedure, a first user generates a symmetric key to be used as a temporary session key, i.e. a transport_key. The first user then proceeds with generating another symmetric key to be used as a wrapper for the original transport_key, i.e. a seal_key. Additional seal keys are generated for each additional channel used in the key exchange procedure. After generating the keys, the first user generates a random 64-bit exchange_id, which is used to link all the generated keys together. An example pseudo-code Listing 1 is provided below.

Listing 1: Generating seal_keys

transport_key = generate_sym_key( )
seal_key = generate_sym_key( )
// for each additional channel: seal key [n] = generate sym key( )

In some embodiments of the present invention, to fasten the key exchange process, the first user immediately sends out their public identity key during the key exchange procedure. To protect that key from tampering, and a potential MiTM risk, it is encrypted using the transport_key resulting in a sealed_identity_key. This encrypted representation can be safely sent together with any of the individual key exchange packages, but is sent by default with the key exchange package that goes through the secure channel (i.e. the security system network) as it does not pose limits on the package sizes like some of the channels might (i.e. length limit in SMS messages).

In some embodiments of the present invention, the first user encrypts the transport_key with the seal_key, resulting in a sealed_key structure. If more than two channels are used, this procedure is repeated with each seal key iterating over the result of the previous step. In some embodiments of the present invention, the first user then packs the resulting sealed_key together with the exchange_id and the sealed_identity_key from the previous step in a key exchange package and sends it to the first (i.e. secured) channel which is the security system hub in this example. Packing and sending the sealed_identity_key is optional and can be performed at later stages.

An example pseudo-code Listing 2 is provided below.

Listing 2: Encrypting multiple channels

sealed_identity_key = encrypt(transport_key, identity_key)
sealed_key = encrypt(seal_key, transport_key)
// with additional channels: sealed_key = encrypt(seal_key_[0],
// encrypt(seal_key_[1], ... (encrypt(seal_key_[n−1], session_key))))
message = pack(‘key_exchange’, exchange_id, sealed_key,
sealed_identity_key)
send(hub.id, message)

In some embodiments of the present invention, the first user then proceeds with creating another key exchange package storing in it the exchange_id, seal_key and the address/means of contacting the first, secured channel for retrieval of the first package, for example, the security system hub's node ID. The first user then sends this package directly to a second user using the second channel, in this case via an SMS message or an email. This step is repeated for each additional channel used, and node IDs need to be included only in one of the messages. An example pseudo-code Listing 3 is provided below.

Listing 3: Sending additional channel packages

// persistent data, stored in the protected storage

| | |
|---|---|
| bob = { | exchange_id: exchange_id, phone_number: |
| | <picked_phone_number>, session: |
| | transport_key } |

message = pack(‘key_exchange’, exchange_id, seal_key, self.node_id,
hub.node_id)
// for each additional channel: message_[0..n−1] = pack(‘key_exchange’,
// exchange_id, seal_key_[0..n−1])
sendSMS(bob.phone_number, message) // or email

In some embodiments of the present invention, the first user stores the exchange_id and transport_key, along with the basic information of the second user, in their local protected storage and awaits response for this particular exchange_id. The first user's hub is in possession of the sealed_key, and the second user is in possession of the seal_key, where both are useless on their own. Thus, even if there was an eavesdropper with full access to one channel, such as by hacked into the security system or hacking into the mobile provider, -hey do not have sufficient data to hijack the session and put themselves in the middle. For a successful attack, an attacker must have full control (including the ability to block/modify the data being exchanged) over all channels through which the key exchange is performed. Since the channels used are independent from each other an attack cannot be performed from within any one channel thus guaranteeing that no provider alone can perform such an attack.

In some embodiments of the present invention, the second user receives the SMS or email (and packages from other channels if more than two are used) and proceeds to contact the first (i.e. secured) channel to obtain the first part of the message. In some embodiments of the present invention, the second user does so by sending a get_key_exchange request to the hub the first user specifies in the first user's SMS or email with the provided exchange_id. In some embodiments of the present invention, the get_key_exchange message for any specific exchange_id can be executed only once, e.g., upon retrieval the security system hub delivers the associated key exchange package and immediately deletes it from its storage. In some embodiments of the present invention, this one-time use ensures that for a successful temporary session establishment nobody but the first user can access the stored key exchange on a security system hub. If someone intercepts it and calls the hub before the first user gets the chance, any further attempt from the first user would result in failure and the link would not be made, at which point the first user can notify the second user that somebody intercepted his message. In some embodiments of the present invention, if the second user retrieves the key exchange package from the hub, nobody after the second user will be able to get it even if they have the correct exchange_id. An example pseudo-code Listing 4 is provided below.

Listing 4: Sending additional channel packages

| alice_sms = readSMS( ) // or email | |
|---|---|
| // for each additional channel: allice_[channel] = read[channel]( ) | |
| hub = connect(alice_sms.node_id) | |
| message = pack(‘get_key_exchange’, alice_sms.exchange_id) | |
| send(hub.id, message) | |
| alice_hub = read(hub.id) | |
| // persistent data, stored in the protected storage | |
| alice = | { id: alice_hub.node_id, |
| | exchange_id: alice_sms.exchange_id, |
| | phone_number: alice_sms.phone_number } |

In some embodiments of the present invention, obtaining all key exchange parts sent by a first user and therefore the ability to obtain the transport_key is packed within them. The second user has to use the seal_key from the SMS or email to decrypt the sealed_key from the key exchange part obtained from the first user's hub after which a temporary key exchange session can be considered established. An example pseudo-code Listing 5 is provided below.

Listing 5: Decryption of channel packages

transport_key = decrypt(alice_sms.seal_key, alice_hub.sealed_key)
// with additional channels:
// decrypt(alice_[channel n−1].seal_key,
// decrypt(alice [channel n−2/.seal key. ... (
// decrypt(alice_[channel 0].seal_key, alice_hub.sealed_key))))
// persistent data, stored in the protected storage
alice += {session: transport key}

In some embodiments of the present invention, if the faster method for key exchange is being used, namely the first user's public identity key is packed together with one of the key exchange messages (i.e. the one going through the security system in this case), then it can be immediately extracted from the message and stored for later authentication purposes. An example pseudo-code Listing 6 is provided below.

Listing 6: Fast identity key extraction

alice_ik = decrypt(alice.session, alice_hub. sealed_identity_key)
alice += {identity: alice_ik}

In some embodiments of the present invention, the temporary key exchange session declared (identified by the exchange_id and transport_key) to complete the key exchange procedure the second user needs to send to the first user a public identity_key, and vice versa, encrypted by the agreed transport_key. While public identity keys are considered public, the public identity keys are encrypted during transfer to prevent a MiTM attack as no passive or active eavesdropper holds the transport_key needed for tampering with the keys. Even though those keys are sent through a secured channel, namely the security system network, encrypting the keys with a transport_key prevents an attack from within the security system network as well. An example pseudo-code Listing 7 is provided below.

Listing 7: Encrypting with transport_keys

Bob:
enc_identity_key = encrypt(alice.session, self.identity_key)
message = pack(‘key exchange’, alice.exchange id, enc identity key)
send(alice.id, message)
Alice:
bob_hub = read(hub, bob.id)
bob_+= decrypt(bob.session, bob_hub.enc_identity_key)
// persistent data, stored in the protected storage
bob += {id: bob hub.node id, identity: bob ik}
enc_identity_key = encrypt(transport_key, self.identity_key)
message = pack(‘key_exchange’, exchange_id, enc_identity_key)
send(bob.id, message)
Bob:
alice_hub = read(hub, alice.id)
alice_ik = decrypt(alice.session, alice_hub .enc_identity_key)
alice += {identity: alice_ik}

In some embodiments of the present invention, to quicken the key exchange process, as discussed supra, the first user packs their public identity key together with the key exchange message. This gives the second user the ability to immediately extract the first user's public identity key cutting down on the communication requirement. Using this method, the second user immediately obtains the first user's public identity key. Thus, to finish the key exchange only the second user needs to send back his identity key to the first user. An example pseudo-code Listing 8 is provided below.

Listing 8: Extraction of public identity key

Bob:
enc_identity_key = encrypt(alice.session, self.identity_key)
message = pack(‘key_exchange’, alice.exchange_id, enc_identity_key)
send(alice.id, message)
Alice:
bob_hub = read(hub, bob.id)
bob_ik = decrypt(bob.session, bob_hub.enc_identity_key)
// persistent data, stored in the protected storage
bob += {id: bob_hub.node_id, identity: bob_ik}

In some embodiments of the present invention, the temporary key exchange session is terminated and both the first user and the second user have their respective node IDs and public identity keys which are required for future session establishment. In some embodiments of the present invention, both the first user and the second user have the other's phone numbers (or emails, or any other identifiable parameter obtained through the security system independent channels) so they can recognize each other without providing the security system network any of their personally identifiable data ensuring they both stay anonymous to the security system network.

In some embodiments of the present invention, while this key exchange offers security given the extremely low likelihood of hacking and obtaining full control over all independent channels, there are two additional checks that can be optionally performed to ensure no MiTM attack has occurred. In some embodiments of the present invention, security system hubs provide means of obtaining a public identity key for any given node ID in the security system network, so immediately after the key exchange both the first user and the second user can verify with their hubs if they have the matching public keys. In some embodiments of the present invention, this method relies on trust in the security system network security. In some embodiments of the present invention, to perform a successful MiTM attack, the adversary has to obtain full control over all independent key exchange channels and that also includes the security system network.

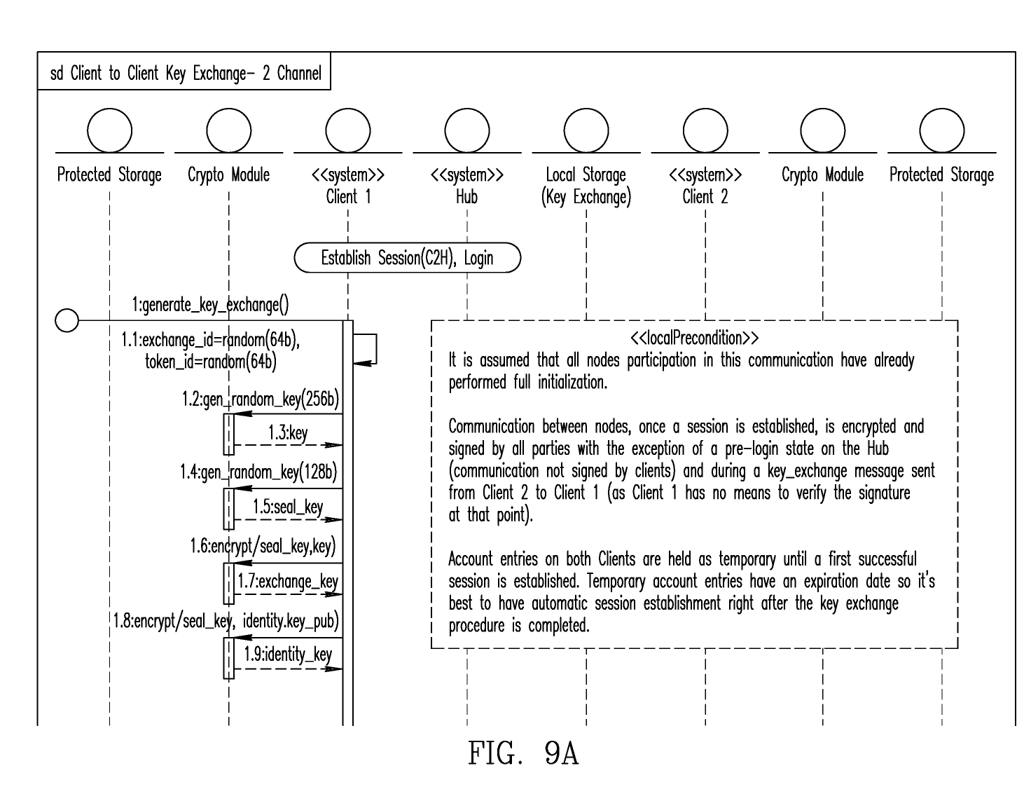

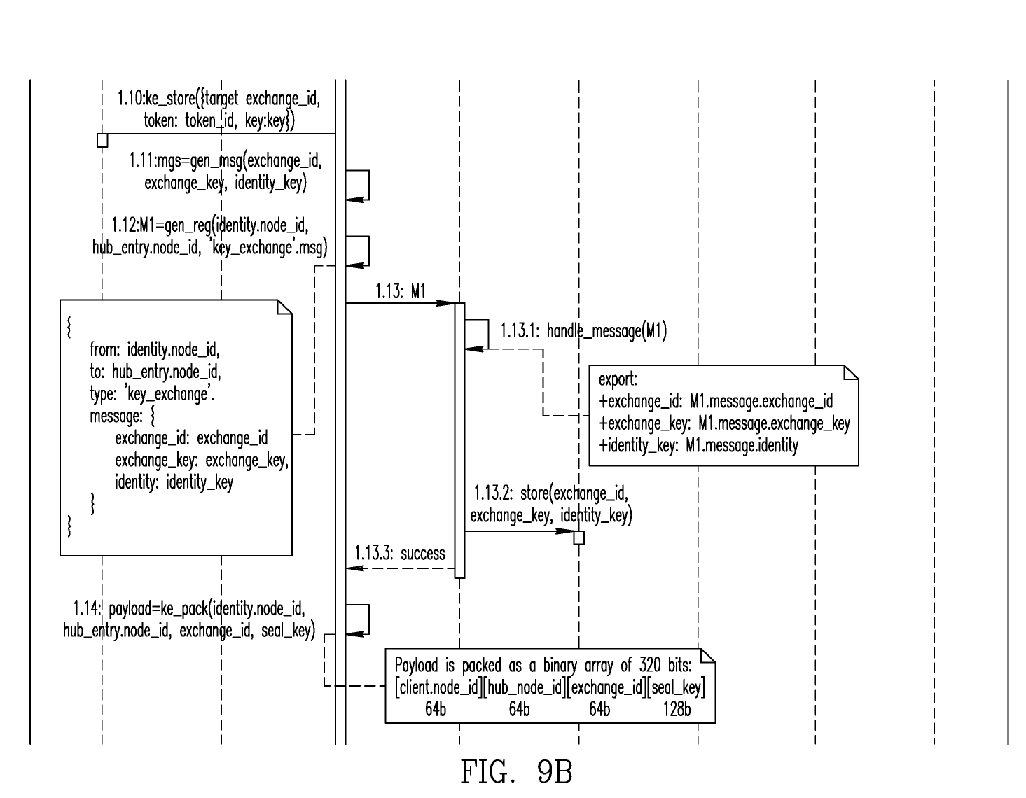

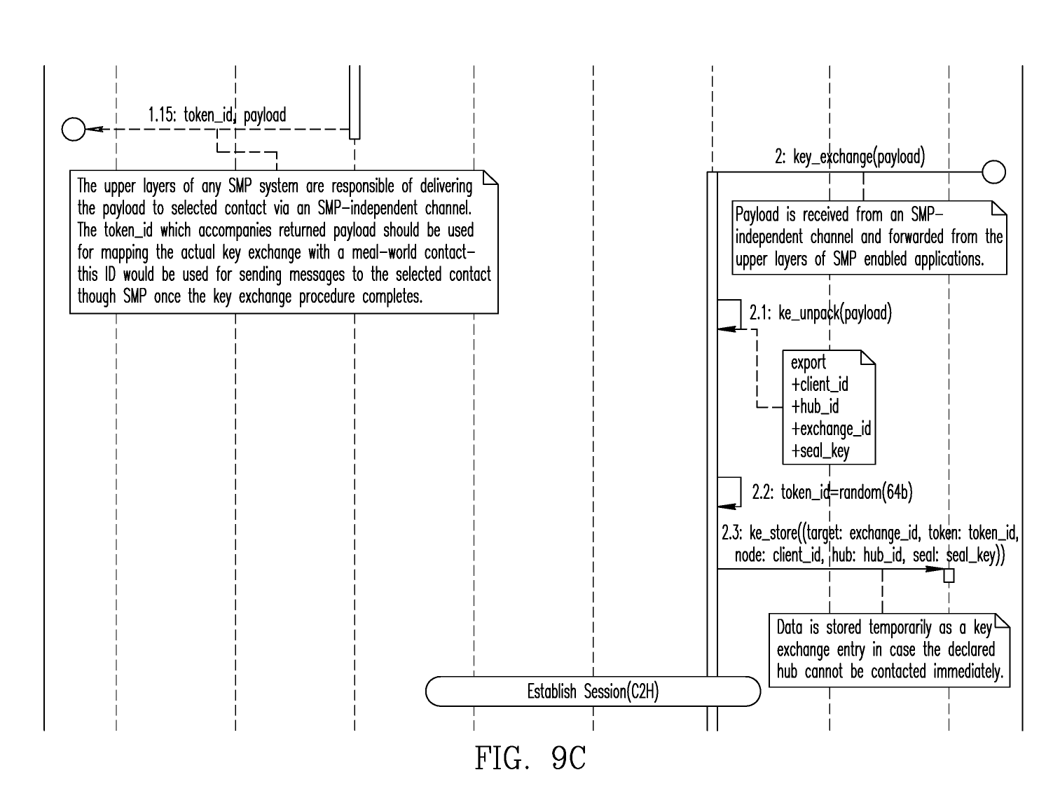

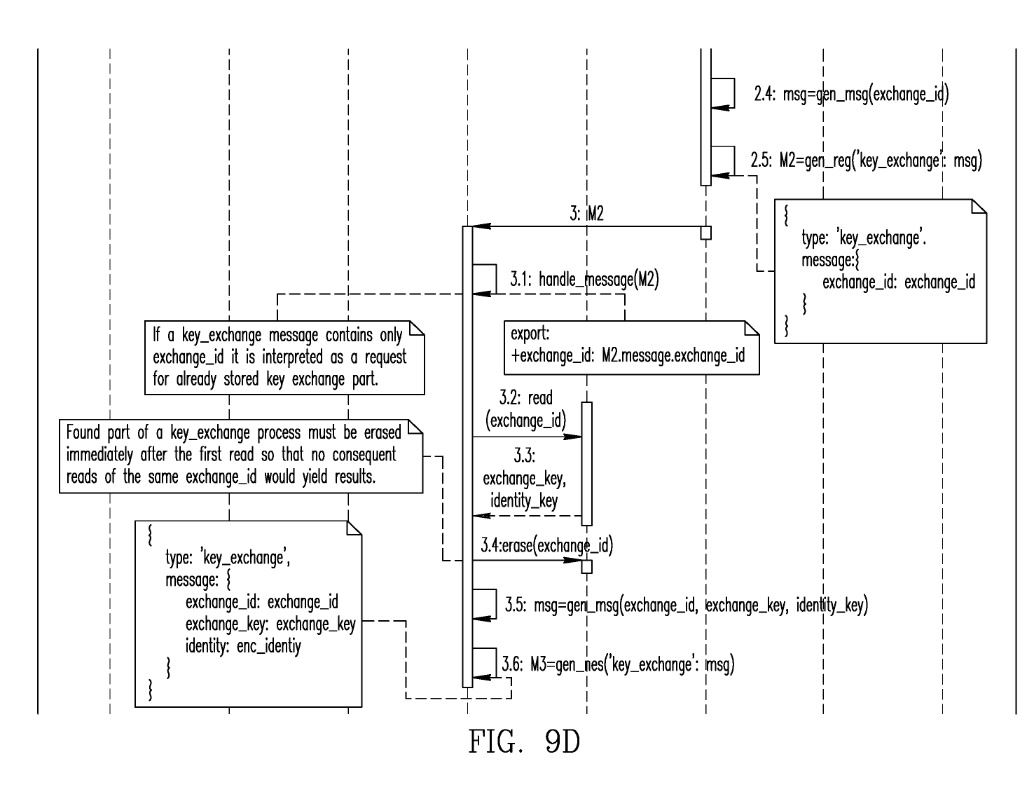

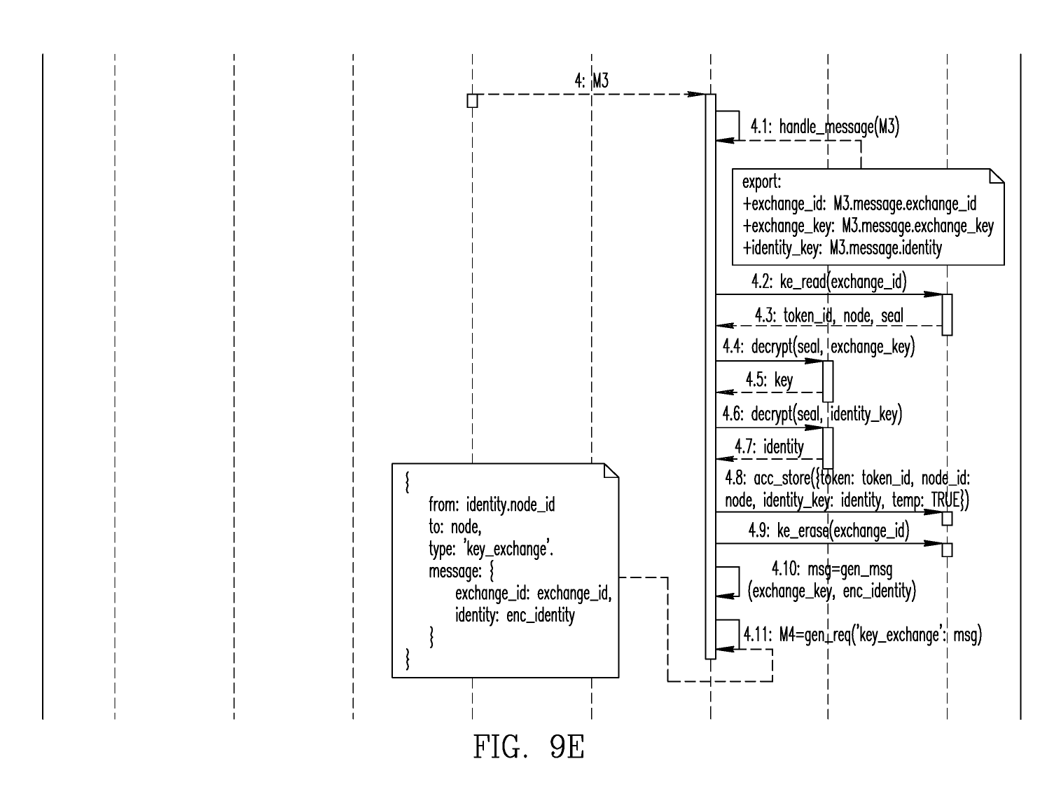

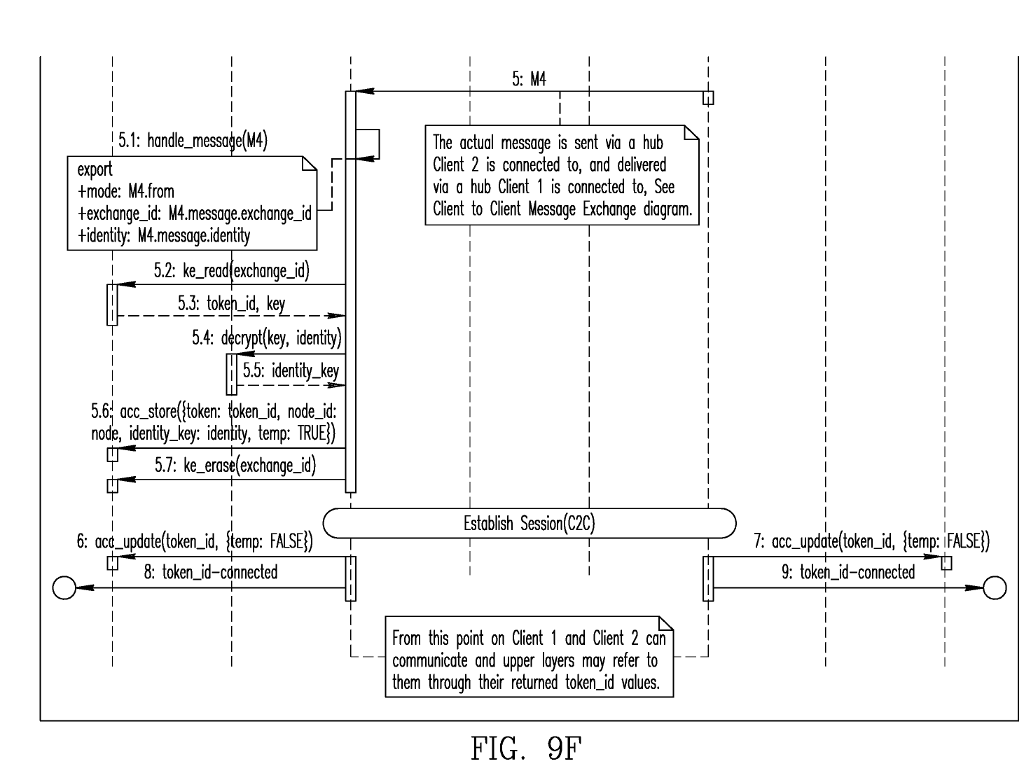

Diagrams illustrating an example client to client key exchange process in accordance with the present invention are shown in FIGS. 9A, 9B, 9C and 9D.

### Human Verification

In some embodiments of the present invention, to obtain a maximum level of security, users can perform personal, human verification over a hard to fake channel such as direct contact or more commonly, e.g., a phone call. In some embodiments of the present invention, to start the human verification procedure both sides pass their own and each other's public identity keys through an adequate key reduction function (e.g., SHA-256 hash) to produce key fingerprints. These fingerprints are then transformed to a base of a number of words present in an application dictionary in order to turn the fingerprint into human readable words. As shown in the following example, own_keywords represents words fingerprint of one's own public key, and peer_keywords represents words fingerprint of each peer respectively. An example pseudo-code Listing 9 is provided below.

Listing 9: Human verification

own_fingerprint = SHA256(self.identity_key)
own_keywords[ ] = toBase(own_fingerprint, words.length, words)
peer_fingerprint = SHA256(peer.identity_key)
peer_keywords[ ] = toBase(peer_fingerprint, words.length, words)
// number of words will depend on the fingerprint size
// and the number of words available in the system

In some embodiments of the present invention, this process may be performed in the background after the initial key exchange and kept as a record within protected storage to expedite the optional human verification step.

In some embodiments of the present invention, when desired, users contact each other either by meeting in person or by using another hard to fake channel such as a voice call, and initiate the human verification procedure on their respective devices. In some embodiments of the present invention, the security system produces an output of two sets of words (i.e. own_fingerprint and peer_fingerprint) where one user should clearly read the words presented as peer_fingerprint while the other user should verify if those are the exact same words as the words presented (to them) as own_fingerprint. If this verification passes, the process is repeated by the second user, reading the peer_fingerprint output and the first user verifying it against his own_fingerprint output.

In some embodiments of the present invention, once both users verify that they have the same words, the security of the connection is considered extreme. Since for a successful attack a malicious adversary would not only need to seize full control over all channels used for the key exchange but he would also need to beat the 1 in 2²^{²⁵⁶} (i.e. assuming SHA-256) odds of generating a set of interception identity keys which would produce the same key fingerprint on both sides from different interception keys. Note that this system can be easily scaled if higher security strength is required, by utilizing hash functions with larger output smaller collision possibility, which would in turn require larger dictionaries and more words to be read for a complete human verification procedure.

In some embodiments of the present invention, MiTM attacks are only possible during the key exchange phase and these methods attempt to mitigate such potentiality. In some embodiments of the present invention, once identity keys are successfully exchanged, there is no known way to eavesdrop on the conversation without being provided the session key used by two nodes in the security system network.

### Security System Known Peer Authentication

The security system platform also provides a secure key exchange and verification even when independent channels are not available or their independence cannot be guaranteed (e.g., while on a plane, etc.), through “trusted peers.” This mechanism allows users to task some of their already verified peers to perform the key exchange instead of them, or to vouch for another peer already in their contact list, and deliver them the public node key of the desired contact through a secure session.

In the event of a suspected breach, the security system also provides users with means of human verification via voice or other hard to fake channels (e.g., already established secure connection, in-person QR code scan, video conference, etc.). Instead of tedious and error-prone comparing of key fingerprints, users are asked to compare several words in their native language which represent a 1:1 map to their public node keys.

Another advantage of the security system key exchange scheme is that it enables users to identify each other without revealing anything about themselves to the security system network. For example, if one of the independent channels used for key exchange is SMS, it allows two users to identify each other via their phone numbers without exposing anything about their identities to the security system network. This keeps users anonymous to the security system platform, while still reliably verifying each other.

### Security System Protected Storage

Protecting data at rest in modern data protection suites is often left to the underlying operating system (OS) or worse, omitted altogether. Under the assumption that the data in transit was properly protected, this leaves a logical attack vector for malicious adversaries, i.e. the devices themselves. Such attacks usually happen by stealing the target device and analyzing the contents stored on it or by utilizing backdoors or malware to obtain the sensitive data. Even if there is no active attack, if data at rest is not properly protected, it might leak in the event of device loss or discarding.

To address this issue, the security system platform provides a solution for protecting local storage. An operating system independent encrypted virtual file system protected by the user's input (e.g., password, dongle, smart card, biometrics, etc.) is used to store all sensitive material exchanged through the security system network (such as account, keys, contacts, messages and files with managed privileges). This ensures that without a valid user authorization, stored data cannot be read, modified, or deleted. One skilled in the art can utilize the security system platform of the present invention as described herein to employ protected storage to securely store other sensitive application data such as configuration, personally identifiable information, and payment information.

In corporate and bring you own device (BYOD) settings, the security system protected storage can be deployed in such a way that it conditionally requires authorization by both the client and administrator before the data within it can be accessed. This eliminates the need to securely wipe the entire devices of ex-employees, for example, as the local protected storage becomes inaccessible when the administrator removes authorization.

In addition to local storage protection, the security system platform of the present invention is operative to resist attacks on its working memory (e.g., random access memory (RAM) scraping, cold boot attacks, etc.). It runs multiple rounds of encryption (i.e. rotary encryption) on the keys being used, circulating them around the working memory, CPU registers and nonvolatile storage in such a way that no single point holds any of the keys in their complete states. When data encryption or decryption is required, the target encryption key is reassembled and used only in the same pipeline as the desired action, after which the key is purged and the rotary encryption scheme resumes.

Note that in some embodiments, the use of the techniques described supra together may have an impact on performance. Nevertheless, in time critical applications and already secured environments, the security system can be customized to strike a balance between speed and magnitude of security by reducing the combination these active defenses or by keeping the keys in the working memory for a short period. One skilled in the art, e.g., application developers, can fine tune these parameters and choose the amount of security customization exposed to users.

In some embodiments of the present invention, every security system node stores its data in a locally built and controlled protected storage. In some embodiments of the present invention, the controlled protected storage represents a strongly encrypted virtual partition/file system protected by the user's password. In some embodiments of the present invention, the controlled protected storage is configured such that without the user's password reading the data from it is unfeasible protecting against situations where a security system enabled device might be lost, stolen or compromised by third party software. In some embodiments of the present invention, protected storage is initiated once per security system enabled application (e.g., on the first start) and is used for any persistent or temporary sensitive data by both the security system core subsystem and everything that might utilize it. In some embodiments of the present invention, an application utilizing the security system can benefit from storing the data in a secure fashion that the protected storage provides.

In some embodiments of the present invention, to initiate the protected storage, first a symmetrical storage key is generated, i.e. a storage_key. In some embodiments of the present invention, the storage_key is a master key to the protected storage and everything stored in it is encrypted using this storage_key. In some embodiments of the present invention, given its sensitive nature, the protected storage is never stored directly. In some embodiments of the present invention, a user input of sufficient entropy (in dependence on the key itself) is required, and then that input is used through a strong key derivation function to generate a user_key. The storage_key is then encrypted using the user_key, and then stored in its encrypted form along with KDF parameters (i.e. salt, iterations, etc.) used in the key derivation function.

In some embodiments of the present invention, this ensures that whenever the storage_key is required to access the protected storage a user must enter their password from which a user_key is derived, which is then used to decrypt the stored encrypted storage_key, which is finally used for accessing the protected storage.

In some embodiments of the present invention, the storage_key is held in the working memory only when there is activity that requires access to the protected storage; where this behavior is configurable by security system users themselves. In some embodiments of the present invention, this ensures that even if the underlying operating system (OS) crashes and does a memory dump for analyzing the crash, the storage_key will not be retrievable from that memory dump. In some embodiments of the present invention, due to the fact that the user_key and the storage_key work in different domains, it is also possible to change the user password without generating a new storage_key and having to re-encrypt the entire protected storage.

In some embodiments of the present invention, an additional benefit of the protected storage is that it can be backed by simple cloning without the risk of data leakage as long as the user's password remains secret. In some embodiments of the present invention, if the application utilizing the security system uses its facilities to store its own data in the protected storage, the application can also benefit from easy backup.

In some embodiments of the present invention, to further increase security of such backups, the security system by default requires a different password for protected storage backups. In some embodiments of the present invention, this is done so that a backup password leak does not endanger the overall security of the protected storage. In some embodiments of the present invention, re-encrypting the protected storage also allows for partial backups (e.g., backup only the contacts list, only selected messages etc.).

### Security System Service Layer

The security system service layer is an extension mechanism to the security system platform aimed at providing additional features to the security system platform. The extensions utilizing the security system service layer are referred to as services.

Services are structured in a client hub hybrid, i.e. they function as hubs towards other nodes in the security system network, but also as clients towards the already established hubs in the network. Services cannot exist on their own as they do not store and authorize accounts. Instead, services are registered within the security system network in a similar fashion as other hubs and hubs themselves determine the level of access to client data for each service.

In one embodiment, services are split into two categories: system and independent services. System services are automatically authenticated and maintained by the security system network itself as they provide extensions which are considered a part of the security system platform. Independent services are typically maintained by third-party providers and require client authorization before they can interact with a client, e.g., if a service requires access to the user's account balance (i.e. how much credit they have in the system) the client must explicitly allow such access before the service can read or modify their balance sheet.

Several features of the security system are performed by system services including Device Linking and Migration, File Sharing and Permissions, Business Account Management, and Cloud Storage.

Use of the security system service layer by third parties provides businesses with a secure and anonymous platform through which they can offer their services to a wide audience without the fear of somebody snooping on their users and without the costs, risk, and complexity of maintaining their own public key infrastructure. For example, a retailer might provide their catalog through the security system network by registering a specific service for the catalog. This would allow them to directly and securely deliver the catalog to their clients and optionally get feedback, without fear of corruption by modification or injection while en route. Clients can also be certain the catalog came from the intended retailer as no one is able to spoof the retailer's verified signature.

Since services act as hubs towards clients, they are not mandated to follow the same strict anonymity guidelines as the security system platform. If a third party service such as a payment processor needs to obtain personally identifiable data, for example, it may make this request directly from the user. Sensitive data is transmitted directly, encrypted by a unique session key established between the client and the service, ensuring that nobody but the user and the targeted service can gain access.

### Security System Hub Lists

In some embodiments of the present invention, to support the methods of operation described herein, a network of security system hubs is maintained. In order to support such a backbone several methods are performed by the security system hubs that are not normally available to other security system nodes (e.g., services, clients, etc.). those methods cover hub list and hub authentication.

In order for security system nodes, both hubs and clients, to be able to make a distinction between their types, a list of all hubs is accessible to both at all times. In order to connect to the security system network nodes are aware of this list a priori. Thus, the hub list is exported and bundled with any security system enabled application. To reconcile the security requirement that the hub list is maintained only by hubs (so that no client can interfere with the security system network) with the requirement that all nodes have the hub list accessible at all times, there are two hub list structures provided: (1) a master hub list and a (2) cached hub list. The master list is maintained by the hubs themselves and the cached list is obtained from the hubs and stored locally by security system nodes.

In some embodiments of the present invention, the master hub list is maintained within the security system active record. That way only hubs can modify it and they can provide a specially packed version (i.e. cached hub list) to other nodes upon request. The initial entry of a hub on this list is performed by an already active hub that vouches for it. In some embodiments of the present invention, this list is used not only to provide a source for the cached hub list but is also used in the hub authentication procedure (described in more detail infra) since once put on this list a hub can authenticate to any other hub by signing an authentication message.

In some embodiments of the present invention, the cached hub list is a read only carbon copy of the actual master hub list stored locally on all security system nodes. It represents an entry point to the security system network as without it nodes would not know how to connect to a hub, and therefore to each other. The initial cached hub list is delivered by exporting the master hub list from any of the active hubs (through call level interface (CLI) or other suitable interface) and bundling it together with all security system powered applications. After installation, an updated cached hubs list is periodically retrieved from the connecting hub (i.e. after a session is established). While update intervals are a matter of service optimization and configuration, it is preferable to update this list at least once per day, preferably during the first connection with a hub on a particular day. The cached hub list is preferably stored in protected storage, either as a file or as local SQLite table or within the local bucket (if available), to prevent outside tampering.

### Security System Hub Authentication

In some embodiments of the present invention, before the security system network accepts a hub, it must pass a rigorous process of hub authentication and verification. This is performed to prevent rogue hubs ‘snatching’ the security system network and/or obtaining access to sensitive data. The process of hub authentication is as follows: (1) an administrator generates a hub authentication package (HAP) on an existing hub in the security system network and transfers it to the hub candidate. Preferably, the HAP is transferred manually and not through the network; (2) the hub candidate then loads the HAP and begins the hub authentication procedure with the hub listed in the HAP. If successful, the hub candidate is added to the hub list and is provided with all information needed to join the needed active record cloud.

In some embodiments of the present invention, every hub on the system is capable of providing authentication services to other hub candidates, and therefore every hub can generate HAPs. While the interface for producing HAPs is left to the discretion of the implementer (CLI, interactive shell, UI, etc.) the generation mechanism and the final output is similar. Immediately after starting the HAP generation procedure the administrator inputs a HAP password (hap_password). This password is used to protect the HAP from reading and/or tampering in transit. The protection procedure is similar to the procedure used to create the protected storage, i.e. the hap_password is put through a key derivation function (PBKDF2 or scrypt) with appropriately large number of iterations (hap_iterations) and salt (hap_salt) to produce the hap_user_key. Upon generation, the hub stores the id, timestamp in its local protected storage. If a retry counter is added as an additional security measure, the countdown value is added to the HAP entry as well. Lastly, the generating hub returns a single HAP file/structure of a previously selected format to the administrator. That structure holds the HEP id, timestamp and key, encrypted by the hap_protection_key and the hap_protection_key encrypted by the previously derived hap_user_key, alongside all parameters necessary for a successful key derivation based on the HAP password. The structure also stores the node ID of the generating hub.

In some embodiments of the present invention, when the hub candidate obtains the HAP file/structure it immediately attempts to verify the HAP and to register itself as a hub. The steps to do so include: (1) the hub candidate requests the administrator to input the HAP password so that the HAP can be read; (2) the hub candidate checks the timestamp to make sure that the HAP's time to live (TTL) has not expired; (3) the hub candidate creates an account (as a client), if it did not already; (4) the hub candidate connects to the hub specified in the hub_id portion of the HAP; (5) the hub candidate establishes a session and login to the aforementioned hub.

Once the above steps are complete, the hub candidate sends an authenticate_hub message to the connected hub. This message contains the extracted id from the provided HAP. On the other side, the hub searches for a hub authentication entry in its local protected storage and once found responds with an authenticate_hub_challenge message. This message contains a random 128-bit challenge to the hub candidate. When the hub candidate receives this challenge it uses the key from the provided HAP to encrypt the challenge and send back to the hub an authenticate_hub_response message containing this encrypted block.

In some embodiments of the present invention, the hub then decrypts the encrypted block retrieved from the hub candidate and checks if the response matches the challenge. If it matches, the hub makes a new entry in the hub list filling the fields with the information from the connected hub candidate. The status field is set to inactive by default, as it is responsibility of the hub candidate to maintain its presence in the hub list. As a final step, the hub returns connection parameters for the security system active record to the hub candidate and removes all local traces of the HAP including the hub authentication entry in its local protected storage.

In some embodiments of the present invention, when the hub candidate receives these parameters it connects to the security system active record and declares itself as active by altering the status entry of its own record in the hub list. It also deletes all traces of the HAP it may have stored locally and breaks the connection with the hub since it is no longer needed. Note that authenticated hubs in the same network communicate through the security system active record cloud. After the above procedure is complete, the hub candidate considers itself a fully privileged hub and begins accepting connections from security system users.

### Message Routing Anonymization (MRA)

In some embodiments of the present invention, while the security system network provides anonymity by default by providing an account-less system and not storing any user-identifiable data, the actual data routing (to and from node IDs within message headers) is exposed to the security system network so that it can relay messages between nodes. This can be a concern if a system wide breach is suspected as an attacker might infer one's identity by observing their communication patterns. To thwart this the security system employs user selectable message routing anonymization (MRA).

MRA allows individual security system nodes to route their messages through their known peers in such a way that (1) no peer, bar the first one in the chain, knows who the message sender is; and (2) no peer, except the last one in the chain, knows who the message recipient is.

To implement MRA, a security system node first establishes a session with each of the peers (including the intended recipient) making a session_key is available to all of them. The original message (for the intended recipient) is then created, with a field in the header, e.g., ‘to’, set to the intended recipient and encrypted with an adequate session_key from the established session with the recipient. Instead of relaying this message through the security system network to be delivered to the recipient, the sending node creates another message addressed to the last peer in the aforementioned chain, and encrypts it with its respective session_key. This message is then further wrapped in another message addressed for the n−1^{h} peer in the chain and so on until the first peer in the chain is reached.

The entire message packet is then sent to the security system network for delivery to the first peer in the chain. Once the first peer receives and processes this message they recognize it as a relayed message and forwards the remainder of the message packet to the second peer. In this manner, the message travels down the chain until it reaches the last peer who delivers the message to the intended recipient.

In some embodiments of the present invention, the number of peers in the MRA chain is configurable by users. The minimum required to retain anonymity, however, is three. Peers participating in a MRA chain are chosen at random (from one's own trusted peer list). Since the security system allows message relays, the return pathway is different which further increases anonymity of the whole system.

### Business Model

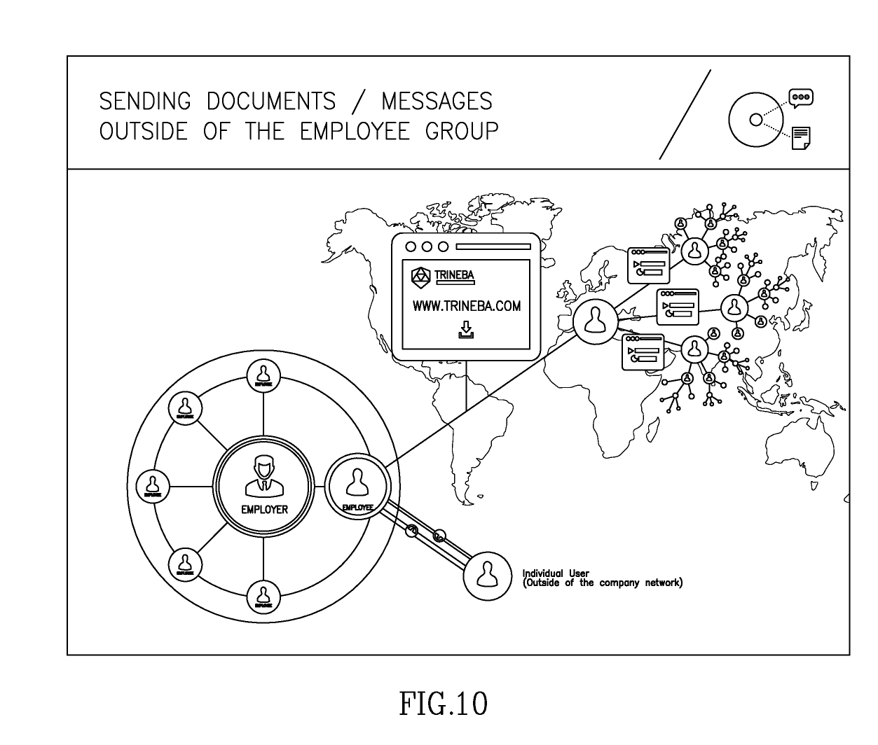

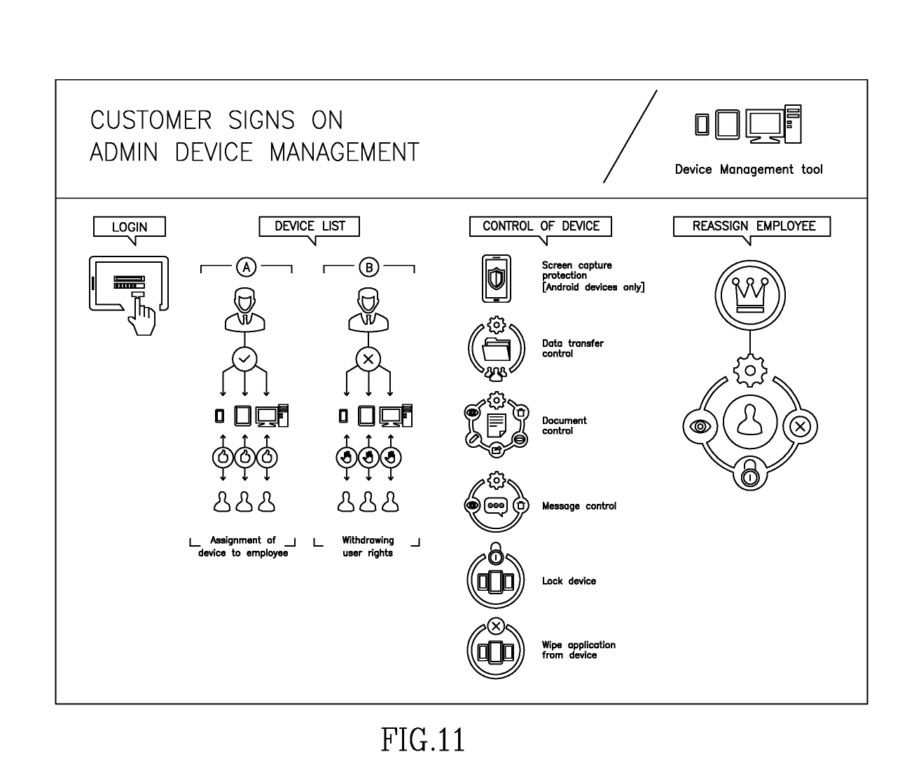

In some embodiments of the present invention, a core model for commercializing the security system of the present invention comprises a business to business based model using existing distribution channels and developing new ones to market and sell products developed from the technology to their customers, clients and members. In some embodiments, the present invention focuses on managing and maintaining infrastructure, upgrading current product line, support and research and development on new products and features. FIGS. 10 and 11 illustrate some embodiments of the present invention.

In some embodiments of the present invention, the business model is divided into three market segments: (1) corporate (brand), (2) original equipment manufacturers (OEM) (integration with client software) as a white label product, and (3) as an instant messaging service available to consumers.

In some embodiments of the present invention, the corporate model is a service adapted to meet the secure and private communication needs of businesses that rely on either business or employee owned phones, tablets and personal PCs as the mode of business communication. This model also allows for secured and private communications and data transfer outside the company's circle to clients at no extra cost. To receive such messages, the client clicks a link to download a free application.

Product packages include: (1) security system administration including (a) storage management, (b) permission management, and (c) user management; and (2) file sharing. Regarding strategic partners, a relationship is setup with existing distribution channels across multiple industries and sectors as a complimentary added value to their existing offerings or as a standalone on a revenue sharing basis.

Regarding a revenue model, the main revenue generation model is based on a corporate per device yearly subscription and is paid on a monthly basis. The monthly billing per corporate customer may increase or decrease depending on the amount of users added or deleted. Regarding extra bandwidth, the model is adapted to allocate most business with the bandwidth needed for normal operations. For companies that require more, i.e. mostly video and picture content, an option to upgrade their bandwidth for an additional fee is offered.

In some embodiments of the present invention, OEM and integration is business that integrates products into the core libraries and offer products as a white label service. In some embodiments, the present invention offers developers and companies easy integration of the technology with the developer's and company's technology. A company that offers electronic health record (EHR) software to health care providers is offered. By integrating with the security system of the present invention, companies can add secure and private communication to their existing product line without the effort and cost of running and maintaining their own infrastructure.

Considering EHR as an example, health care institutions in the United States are required to institute a privacy protection protocol to protect against the dissemination of their patients' health information and to assure that the transmission of such information is secure. By integrating the EHR into the libraries and products incorporating the present invention, health care facilities communicate and send private data to a specific person with restrictions on data. This model also allows for secure and private communications and data transfer outside a company's circle to clients, patients, customers and members at no extra cost. To receive such messages, the client clicks a link to download a free application. The revenue model includes: (1) setup fee (one time), (2) sliding scale per device fee, and (3) bandwidth fee.

In some embodiments, the present invention used to implement instant messaging as a separately branded product available to the public and will generate growth from three points: (1) resellers that cater to a particular niche group; (2) general marketing; and (3) from corporate and OEM.

In some embodiments, the present invention uses a branded free model; e.g., a free application (app) is offered to the public and outside circle groups from corporate and OEM. The present invention uses features, i.e. an administrative panel where a user is able to place restrictions on data they send. Users can purchase products from vendors as a service of the messenger. Such purchases are made via messenger through a money transfer service. Users can transfer money and alternative currencies to other users.

Those skilled in the art will recognize that the boundaries between logic and circuit blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediary components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the claims, any reference signs placed between parentheses shall not be construed as limiting the claim. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first,” “second,” etc. are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of providing secure communications and anonymity in a network, comprising:
providing a plurality of hubs in communication with each other and in communication with a plurality of client nodes;
a first client node establishing a first account-less session with a hub;
said first client node transferring its public key to the hub utilizing a multi-channel key exchange over a plurality of channels;
a second client node establishing a second account-less session with the hub;
said second client node retrieving said first client node's public key from the hub;
said second client node sending its public key to said first client node; and
said first node and said second node establishing secure communications using their exchanged public keys.

2. The method according to claim 1, wherein at least one of said plurality of channels comprises the hub.

3. The method according to claim 1, wherein at least one of said plurality of channels comprises SMS.

4. The method according to claim 1, wherein at least one of said plurality of channels comprises email.
